(19) United States
(12) Patent Application Publication
(10) Pub. No.: US 2008/0003472 A1
(43) Pub. Date: Jan. 3, 2008

(54) Reaction apparatus and electronic equipment

(75) Inventors: Naotomo Miyamoto, Tokyo (JP); Tadao Yamamoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/821,765

(22) Filed: Jun. 25, 2007

(30) Foreign Application Priority Data
Jul. 3, 2006 (JP) 2006-183402
Sep. 27, 2006 (JP) 2006-263053

(51) Int. Cl. H01M 8/06; H01M 8/02

(52) U.S. Cl. 429/19; 429/34

(57) ABSTRACT

Disclosed a reaction apparatus including: a reaction section to receive supply of a reactant, the reaction section being set at a predetermined temperature to cause a reaction; a plurality of electrodes provided to the reaction section; a heat insulating container to house the reaction section therein through a heat insulating space; and a supply/discharge section including a conductor to supply the reactant to the reaction section, and to discharge a reaction product from the reaction section, one end of the supply/discharge section being connected to the reaction section, the other end thereof penetrating a wall of the heat insulating container to an outside, wherein at least one of the plurality of electrodes is electrically connected to the supply/discharge section.

### BACKGROUND OF THE INVENTION

1. Field of the Invention

The present invention relates to a reaction apparatus, to which a reactant is supplied to cause a reaction therein.

2. Description of Related Art

In recent years, the development of a fuel cell as a clean power source having a high energy conversion efficiency has been advanced for mounting the fuel cell in a motorcar or a portable device. The fuel cell is a device of reacting a fuel with oxygen in the air electrochemically to extract electrical energy from chemical energy directly.

Hydrogen is used as a fuel used for the fuel cell. Because the hydrogen is a gas at an ordinary temperature under a normal barometric pressure, the hydrogen has a problem of handling. On the other hand, a reforming type fuel cell producing hydrogen by reforming a liquid fuel including hydrogen atoms such as alcohols and gasoline can easily store the fuel in a liquid state. Such a reforming type fuel cell is required to include a reaction apparatus provided with a reaction section including a vaporizer vaporizing the liquid fuel and water, a reformer reacting the vaporized liquid fuel with high temperature steam to extract the hydrogen necessary for electric generation, a carbon monoxide remover removing the carbon monoxide that is a by-product of a reforming reaction, and the like.

In order to miniaturize such a reforming type fuel cell, the development of a small-sized reaction apparatus called as a micro-reactor composed by stacking reactors such as a vaporizer, a reformer, and a carbon monoxide remover is being advanced. In such a micro-reactor, the reactors such as the vaporizer, the reformer, and the carbon monoxide remover and the like is formed by, for example, joining metal base plates on which grooves used as flow paths of fuels or the like. Moreover, such a reaction apparatus is required to set each reactor at a predetermined operating temperature necessary for the reaction thereof, and the reaction apparatus is sometimes configured to set each reactor at a desired temperature by providing a heater of a heating wire to each reactor to heat each reactor. Because the operating temperature of each reactor is comparatively high, the reaction apparatus is sometimes configured to be provided with a heat insulating container to house each reactor therein in order to improve the thermal efficiency thereof by suppressing the heat radiation to the outside to reduce the heat loss thereof. However, if the reaction apparatus is configured to be heated by the provided heaters, it is necessary to pull out lead wires for applying a voltage to the heating wires of the heaters from the heat insulating container to the outside, and the heat of the reactors is conducted to the outside through the lead wires to generate a heat loss.

On the other hand, the development of a solid oxide fuel cell (hereinafter referred to as an SOFC) capable of enhancing the generation efficiency thereof owing to the high temperature operation thereof is advancing in the fuel cell field. In this case, an electric power generation cell including a fuel electrode formed on one side of a solid oxide electrolyte and an oxygen electrode formed on the other side is used. Because the reaction of the SOFC is performed at a comparatively high temperature (at about 500-1000° C.), the electric power generation cell is housed in a heat insulating container. The pipes as the flow paths of supplying a fuel gas and oxygen, and the flow path of discharging discharged gas; an anode output electrode; and cathode output electrode penetrate the heat insulating container to be connected to the electric power generation cell in the heat insulating container. However, because the operating temperature of the electric power generation cell is comparatively high temperature in the SOFC, the temperature differences between the anode output electrode and the cathode output electrode, both exposed to the outside, and the electric power generation cell are large, and the heat loss owing to the temperature differences easily becomes large.

### SUMMARY OF THE INVENTION

The present invention has an advantage of being able to reduce the heat loss owing to heat conduction from a reactor in a heat insulating container to the outside in a reaction apparatus having a configuration of including the heat insulating container housing a reaction section to set the reactor of the reaction section at a predetermined temperature.

In accordance with a first aspect of the invention, a reaction apparatus includes: a reaction section to receive supply of a reactant, the reaction section being set at a predetermined temperature to cause a reaction; a plurality of electrodes provided to the reaction section; a heat insulating container to house the reaction section therein through a heat insulating space; and a supply/discharge section including a conductor to supply the reactant to the reaction section, and to discharge a reaction product from the reaction section, one end of the supply/discharge section being connected to the reaction section, the other end thereof penetrating a wall of the heat insulating container to an outside, wherein at least one of the plurality of electrodes is electrically connected to the supply/discharge section.

In accordance with a second aspect of the invention, a reaction apparatus includes: a reaction section having a electric power generation cell including two electrodes of a positive electrode and a negative electrode, from which electric power is extracted by an electrochemical reaction of a reactant, the electric power generation cell being set at a predetermined temperature; a heat insulating container to house the reaction section therein through a heat insulating space; and a supply/discharge section including a conductor to couple the heat insulating container with the reaction section so as to supply a fuel for the electric generation to the reaction section and to discharge a reaction product from the reaction section, one end of the supply/discharge section being connected to the reaction section, the other end thereof penetrating a wall of the heat insulating container to an outside, wherein one of the two electrodes in the electric power generation cell is electrically connected to the supply/discharge section.

In accordance with a third aspect of the invention, an electronic equipment includes a reaction apparatus including: a reaction section to receive supply of a reactant, the reaction section being set at a predetermined temperature to cause a reaction; a plurality of electrodes provided to the reaction section; a heat insulating container to house the reaction section therein through a heat insulating space; a supply/discharge section including a conductor to supply the reactant to the reaction section, and to discharge a reaction product from the reaction section, one end of the supply/discharge section being connected to the reaction section, the other end thereof penetrating a wall of the heat insulating container to an outside, at least one of the plurality of electrodes is electrically connected to the supply/discharge section, a electric power generation cell from which electric power is extracted by an electrochemical reaction of the reactant; and wherein a load is driven based on the electric power extracted from the electric power generation cell.

### BRIEF DESCRIPTION OF THE DRAWINGS

The aforesaid and further objects, features and advantages of the present invention will become more apparent from the following detailed description when read in conjunction with the accompanying drawings, in which:

FIG. 1 is an exploded perspective view of a micro-reactor module (reaction apparatus) and a heat insulating package covering the micro-reactor module according to a first embodiment of a reaction apparatus of the present invention;

FIG. 2 is a schematic side view in the case of dividing the micro-reactor module of the first embodiment by function;

FIG. 3 is a plan view showing the neighborhood of the joining area of a heating wire and a pipe member on the under surface of the micro-reactor module of the first embodiment;

FIG. 4 is a sectional view taken along line IV-IV of FIG. 3;

FIG. 5 is a plan view showing a first modification of the neighborhood of the joining area of the heating wire and the pipe member on the under surface of the micro-reactor module of the first embodiment;

FIG. 6 is a sectional view taken along line VI-VI of FIG. 5;

FIG. 7 is a plan view showing a second modification of the neighborhood of the joining area of the heating wire and the pipe member on the under surface of the micro-reactor module of the first embodiment;

FIG. 8 is a sectional view taken along line VIII-VIII of FIG. 7;

FIG. 9 is a plan view showing a third modification of the neighborhood of the joining area of the heating wire and the pipe member on the under surface of the micro-reactor module of the first embodiment;

FIG. 10 is a sectional view taken along line X-X of FIG. 9;

FIG. 11 is a perspective view showing an example of a generator unit equipped with the micro-reactor module of the first embodiment;

FIG. 12 is a sectional view showing a first example of a wiring structure of the installing part of the micro-reactor module to the generator unit in the first embodiment;

FIG. 13 is a sectional view showing a second example of the wiring structure at the installing part of the micro-reactor module into the generator unit in the first embodiment;

FIG. 14 is a perspective view showing an example of an electronic equipment using the generator unit as the power source thereof;

FIG. 15 is a block diagram showing the configuration of an electronic equipment to which a second embodiment of a reaction apparatus according to the present invention;

FIG. 16 is a schematic view of an electric power generation cell in the second embodiment;

FIG. 17 is a schematic view showing an example of an electric power generation cell stack;

FIG. 18 is a perspective view showing a reaction apparatus in the second embodiment;

FIG. 19 is a side view looked from the arrow XIX direction in FIG. 18;

FIG. 20 is a perspective view showing the internal structure of the heat insulating package in the reaction apparatus in the second embodiment;

FIG. 21 is a perspective view of the internal structure of the reaction apparatus of FIG. 20 when it is looked from the under side thereof;

FIG. 22 a sectional view taken along line XXII-XXII of FIG. 18;

FIG. 23 is a schematic view showing how electrons flow in the reaction apparatus of the second embodiment;

FIG. 24 is a view of the under surfaces of a connection section, a reformer, and a fuel cell section in the reaction apparatus of the second embodiment;

FIG. 25 is a sectional view taken along line XXV-XXV of FIG. 24;

FIG. 26 is a sectional view taken along line XXVI-XXVI of FIG. 24;

FIG. 27 is a sectional view taken along line XXVII-XXVII of FIG. 26;

FIG. 28 is a schematic view showing a temperature distribution in the heat insulating package at the time of a steady state operation of the reaction apparatus of the second embodiment;

FIG. 29 is a simulation view showing the state of deformation of an anode output electrode caused by a temperature rise in the reaction apparatus of the second embodiment;

FIG. 30 is a perspective view showing an modification of the internal structure of the heat insulating package in the reaction apparatus of the second embodiment;

FIG. 31 is a perspective view showing another modification of the internal structure of the heat insulating package in the reaction apparatus of the second embodiment;

FIG. 32 is a perspective view showing a further modification of the internal structure of the heat insulating package in the reaction apparatus of the second embodiment; and

FIG. 33 is a perspective view showing a still further modification of the internal structure of the heat insulating package in the reaction apparatus of the second embodiment.

### DETAILED DESCRIPTION OF THE PREFERRED EMBODIMENTS

In the following, the details of a reaction apparatus according to the present invention will be described based on the preferred embodiments shown in the attached drawings. Although various limitations that are technically preferable for implementing the present invention are added to the embodiments to be described in the following, the scope of the invention is not limited to the following embodiments and the examples shown in figures.

### First Embodiment

First, a first embodiment of a reaction apparatus according to the present invention will be described.

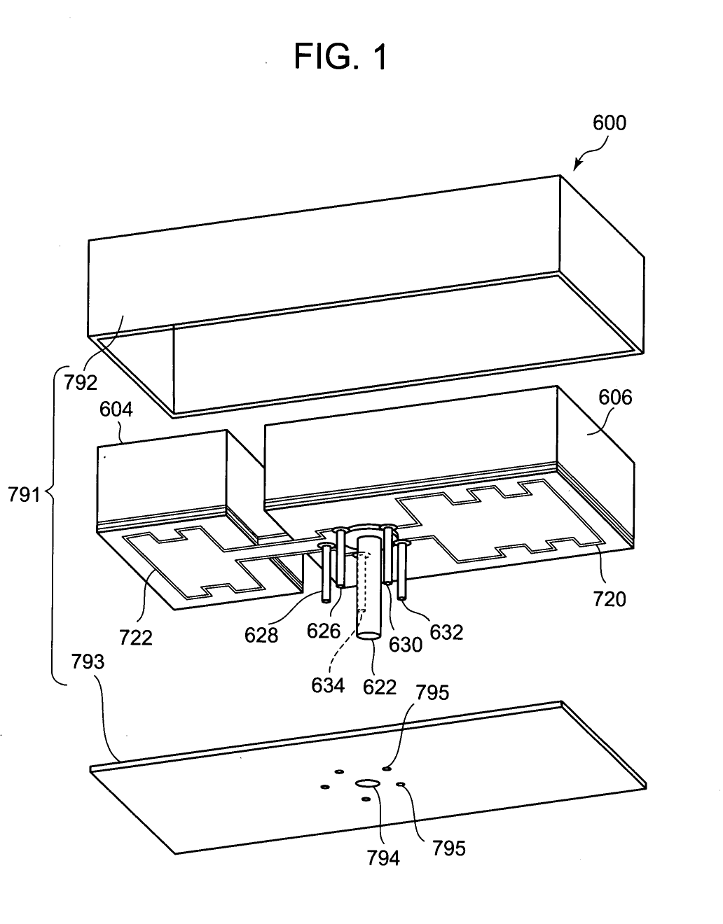

FIG. 1 is an exploded perspective view of a micro-reactor module (reaction apparatus) and a heat insulating package covering the micro-reactor module according to the first embodiment of the reaction apparatus of the present invention.

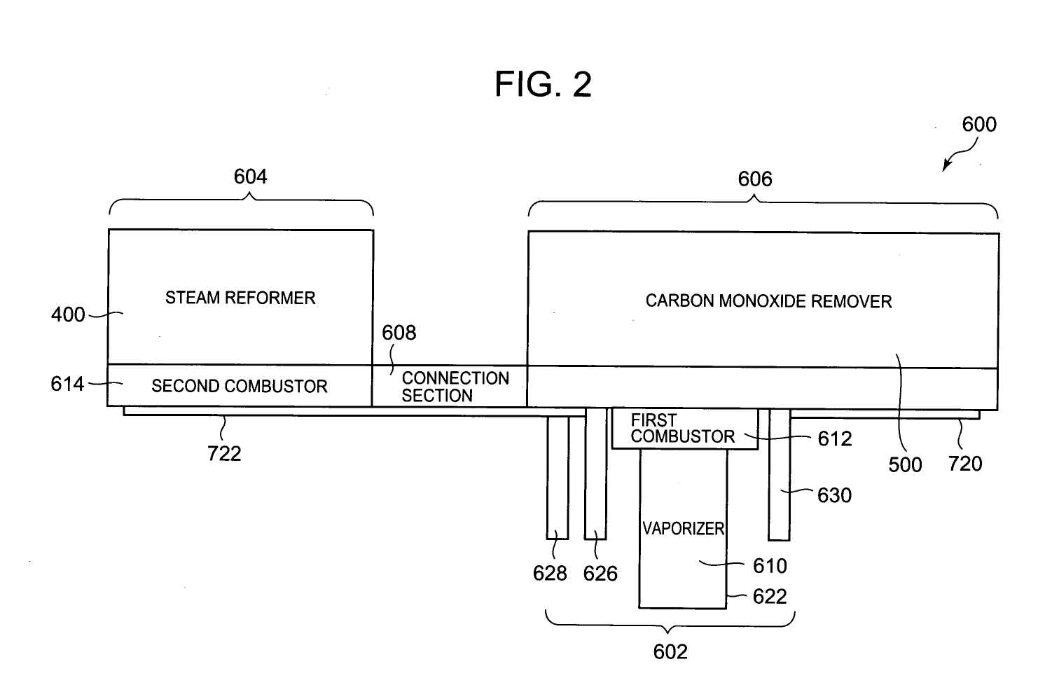

FIG. 2 is a schematic side view in the case of dividing the micro-reactor module of the present embodiment by function.

The micro-reactor module 600 is built in electronic equipments such as a notebook computer, a PDA, an electronic organizer, a digital camera, a portable telephone, a wrist watch, a register, or a projector, and produces a hydrogen gas to be used for a fuel cell.

As shown in FIG. 2, the micro-reactor module 600 includes: a supply/discharge section 602, in which the supply of a reactant and the discharge of a product are performed; a high temperature reaction section (first reaction section) 604, which is set at a comparatively high temperature (first temperature), and in which a reforming reaction occurs; a low temperature reaction section (second reaction section) 606, which is set at a lower temperature (second temperature) than the set temperature of the high temperature reaction section 604, and in which a selective oxidation reaction occurs; and a connection section 608 transmitting a reactant and a product between the high temperature reaction section 604 and the low temperature reaction section 606. The micro-reactor module 600 is housed in a heat insulating package (heat insulating container) 791.

In the supply/discharge section 602, the supply of a reactant from the outside of the heat insulating package 791 to the micro-reactor module 600 and the discharge of a product from the micro-reactor module 600 to the outside of the heat insulating package 791 are performed.

As shown in FIG. 2, the supply/discharge section 602 is provided with a vaporizer 610 and a first combustor 612, and further five pipe members 626, 628, 630, 632 and 634 arranged around the vaporizer 610 and the first combustor 612.

Water and a liquid fuel (such as methanol, ethanol, dimethyl ether, butane, or gasoline) is supplied from fuel containers into the vaporizer 610 individually or in the state of being mixed with each other, and the water and the liquid fuel are vaporized in the vaporizer 610 by the combustion heat in the first combustor 612.

Air and a gaseous fuel (such as hydrogen, methanol, ethanol, dimethyl ether, butane, or gasoline) are supplied to the first combustor 612 individually or as a mixture gas, and heat is generated by the catalytic combustion of the air and the gaseous fuel.

The five pipe members 626, 628, 630, 632 and 634 function as a flow path for supplying a reactant to the micro-reactor module 600 and a flow path for carrying out a product of the micro-reactor module 600. The five pipe members 626, 628, 630, 632 and 634 function as, for example, flow paths for supplying the fuel and air to the first combustor 612 and a second combustor 614, which will be described later, flow paths for discharging the discharged gases of the first combustor 612 and the second combustor 614, a flow path for supplying oxygen to a carbon monoxide remover 500, which will be described later, or a flow path conveying a mixture gas (hydrogen rich gas) in the state in which carbon monoxide has been removed in the carbon monoxide remover 500 to the fuel cell.

The five pipe members 626, 628, 630, 632 and 634 are severally made of a conductor, and also fulfill the role of lead wires for applying a voltage to heating wires 720 and 722, which will be described later.

The high temperature reaction section 604 is mainly provided with a second combustor (heating section) 614 and a reformer 400 provided on the second combustor 614.

Air and a gaseous fuel (such as hydrogen, methanol, ethanol, dimethyl ether, butane, or gasoline) are supplied to the second combustor 614 individually or in the state of a mixture gas, and heat is generated by the catalytic combustion of the air and the gaseous fuel.

The mixture gas produced by vaporizing the water and the liquid fuel is supplied from the vaporizer 610 to the reformer 400, and the reformer 400 is heated by the second combustor 614. In the reformer 400, a hydrogen gas and the like are produced by the catalytic reaction from the steam and the vaporized liquid fuel, and a carbon monoxide gas is produced although the quantity thereof is infinitesimal. If the fuel is methanol, the chemical reactions expressed by the following formulae (1) and (2) are caused. Incidentally, the reaction of producing hydrogen is an endothermic reaction, and the combustion heat of the second combustor 614 is used.

CH₃OH+H₂O→3H₂+CO₂ (1)

2CH₃OH+H₂O→5H₂+CO+CO₂ (2)

The low temperature reaction section 606 is mainly provided with the carbon monoxide remover 500.

A mixture gas including the hydrogen gas and the infinitesimal carbon monoxide gas produced by the chemical reaction expressed by the formula (2) is supplied from the reformer 400 to the carbon monoxide remover 500, and further air is supplied to the carbon monoxide remover 500. In the carbon monoxide remover 500, the carbon monoxide in the mixture gas is selectively oxidized by being heated by the first combustor 612, and consequently the carbon monoxide is removed. The mixture gas (hydrogen rich gas) in the state in which the carbon monoxide has been removed is supplied to the fuel electrode of the fuel cell.

A flow path for supplying the reactant to the high temperature reaction section 604 and a flow path for conveying the products in the high temperature reaction section 604 to the low temperature reaction section 606 are formed in the connection section 608. To put it concretely, a flow path for supplying a fuel and air to the second combustor 614, a flow path for discharging an discharge gas of the second combustor 614, a flow path for supplying the water and the fuel vaporized in the vaporizer 610 to the reformer 400, and a flow path for conveying the products of the reformer 400 to the carbon monoxide remover 500 are formed.

The heating wires (heating sections) 720 and 722 are formed by, for example, patterning a metal thin film. As shown in FIGS. 1 and 2, a heating wire 720 is patterned in the state of being meandering on the under surface of the low temperature reaction section 606, and a heating wire 722 is patterned in the state of being meandering on the under surface from the low temperature reaction section 606 to the high temperature reaction section 604 through the connection section 608. If the low temperature reaction section 606, the connection section 608 and the high temperature reaction section 604 are severally made of a conductor, then an insulating layer 640 made of silicon nitride, silicon oxide, and the like is formed as a film on their under surfaces, and the heating wires 720 and 722 are formed on the front surface of the insulating layer 640. The patterning of the heating wires 720 and 722 on the insulating layer 640 prevents the voltages to be applied from their short circuits with each other.

Incidentally, if the under surfaces of the low temperature reaction section 606, the connection section 608, and the high temperature reaction section 604 are severally made of an insulator, such as ceramics, then the insulating layer 640 is unnecessary, and the heating wires 720 and 722 can be directly patterned.

The heating wire 720 heats the low temperature reaction section 606 at the time of a start, and the heating wire 722 heats the high temperature reaction section 604 and connection section 608 at the time of a start.

Both the ends of the heating wire 720 are connected to the pipe members 630 and 632. Moreover, both the ends of the heating wire 722 are connected to the pipe members 626 and 634. In the following, the structures of the connection sections will be described.

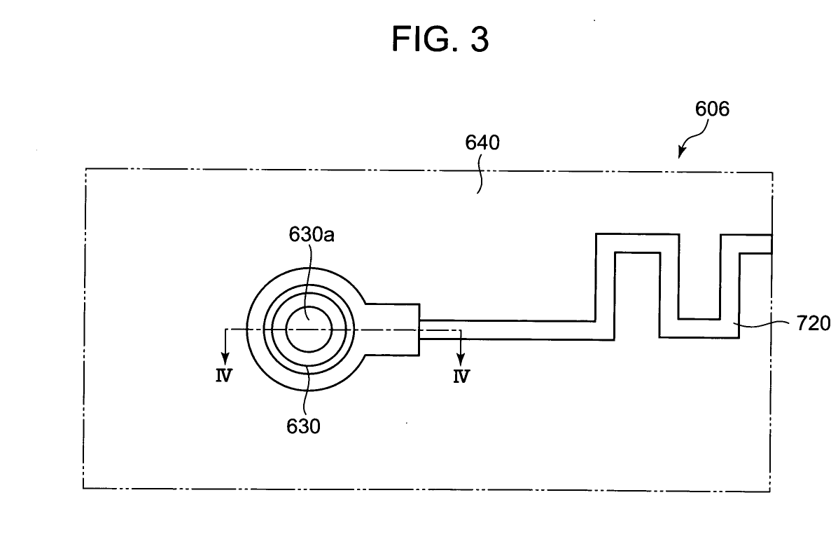

FIG. 3 is a plan view showing the neighborhood of a joining area of a heating wire and a pipe member on the under surface of the micro-reactor module of the present embodiment.

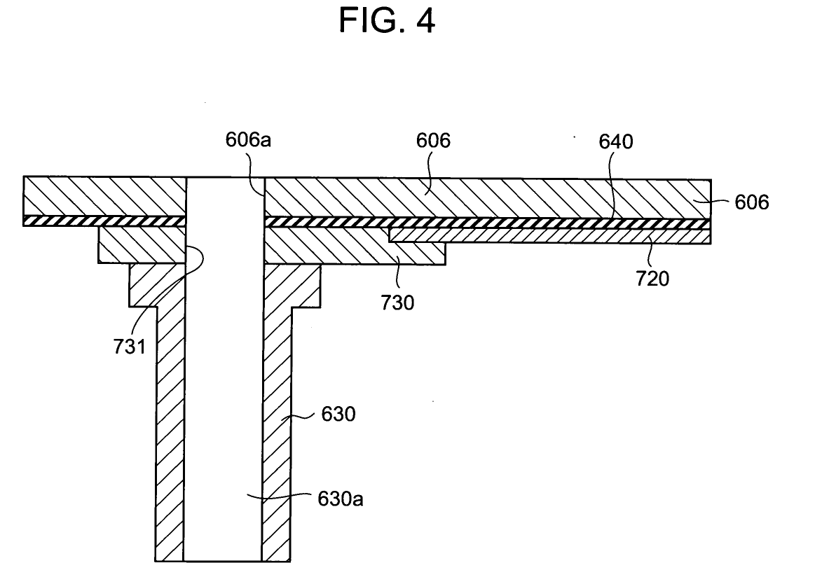

FIG. 4 is a sectional view taken along line IV-IV in FIG. 3.

As shown in FIGS. 3 and 4, the insulating layer 640 is provided on the under surface of the low temperature reaction section 606, and the heating wire 720 is formed on the front surface of the insulating layer 640.

A bonding layer 730 is provided on the front surface of the insulating layer 640 at the connection section of the low temperature reaction section 606 with the pipe member 630. The bonding layer 730 is formed so that a part of the bonding layer 730 may be overlapped with the end of the heating wire 720, which has been previously formed. A through hole 731 is formed in the bonding layer 730 at the same position as that of a hole 606a opened into the inside of the low temperature reaction section 606. The bonding layer 730 has superior adhesion to the insulating layer 640. By sticking an end of the pipe member 630 fast to the surface of the bonding layer 730 on the opposite side to the insulating layer 640, the pipe member 630 is bonded to the low temperature reaction section 606, and a flow path 630a in the pipe member 630 is connected to the hole 606a.

Moreover, the bonding layer 730 has electrical conductivity, and allows the heating wire 720 to be electrically connected with the pipe member 630. For example, gilding can be used as the bonding layer 730 like this.

Similarly, the pipe member 632 is electrically connected with the heating wire 720, and the pipe members 626 and 634 are severally electrically connected with the heating wire 722.

Thereby, the low temperature reaction section 606 can be heated by applying a voltage between the pipe members 630 and 632, and the high temperature reaction section 604 can be heated by applying a voltage between the pipe members 626 and 634.

Next, modifications of the connection sections of the heating wires and the pipe members in the micro-reactor module of the present embodiment will be described.

### [First Modification]

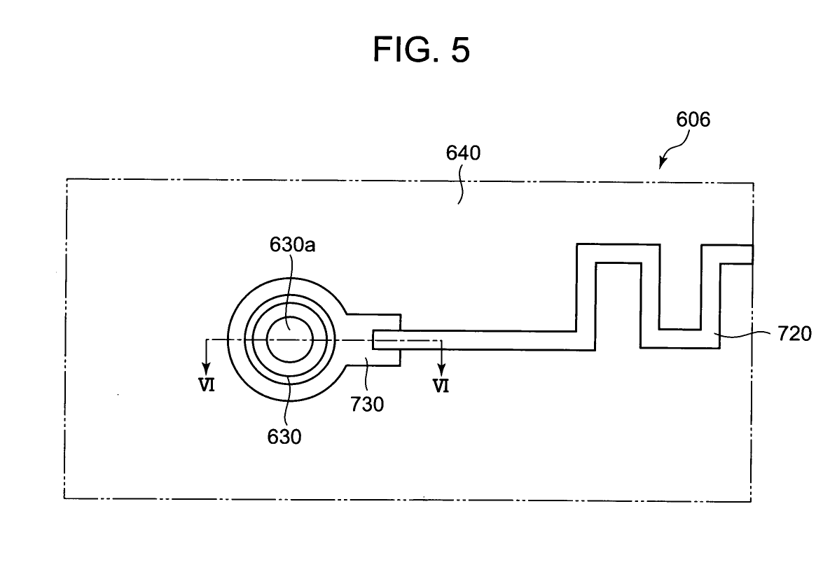

FIG. 5 is a plan view showing a first modification of the neighborhood of a joining area of a heating wire and a pipe member on the under surface of the micro-reactor module of the present embodiment.

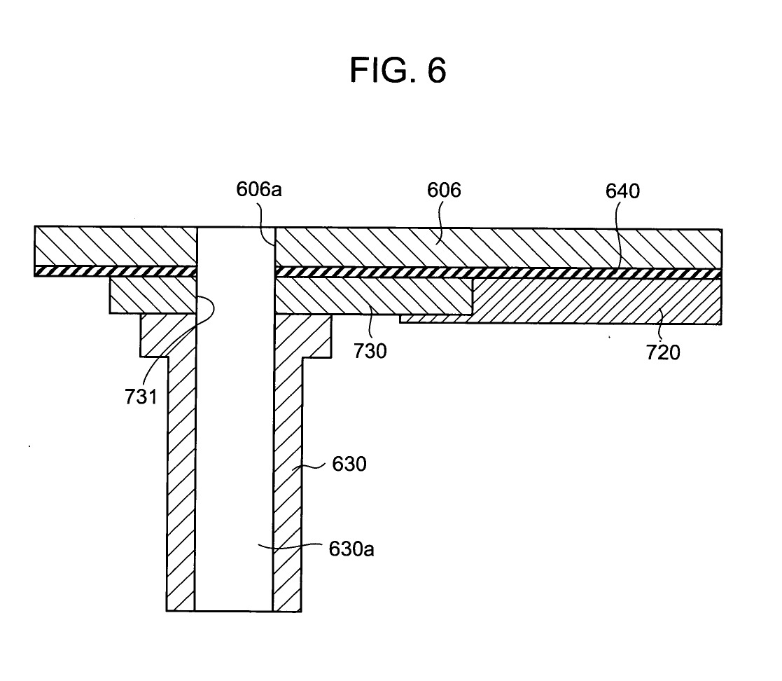

FIG. 6 is a sectional view taken along line VI-VI of FIG. 5.

In the aforesaid first embodiment of FIGS. 3 and 4, the bonding layer 730 is formed after the formation of the previously formed heating wires 720 and 722 so that the bonding layer 730 may overlap with the ends of the heating wires 720 and 722. In the first modification, as shown in FIGS. 5 and 6, for example, after the formation of the bonding layer 730, the heating wires 720 and 722 are formed, and the ends of the heating wires 720 and 722 are overlapped with the bonding layer 730, which have been previously formed.

### [Second Modification]

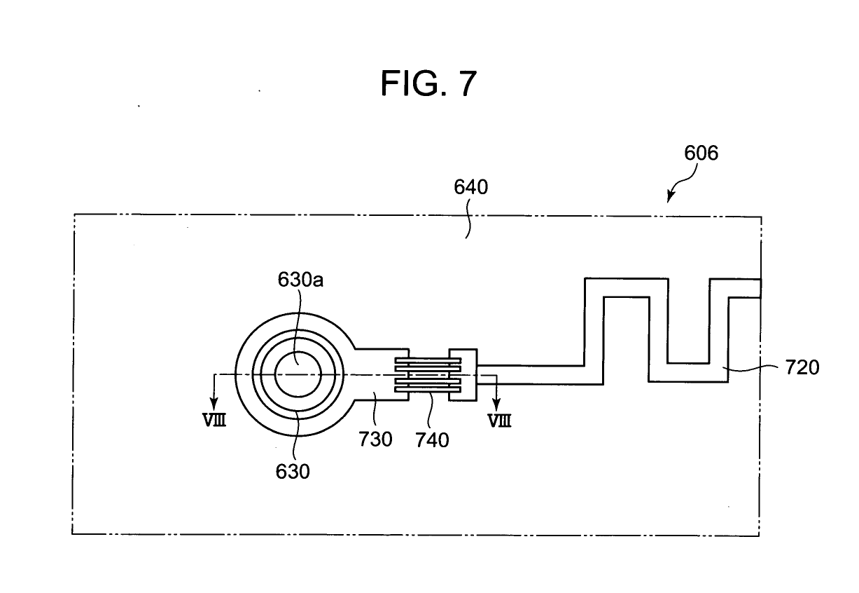

FIG. 7 is a plan view showing a second modification of the neighborhood of a joining area of a heating wire and a pipe member on the under surface of the micro-reactor module of the present embodiment.

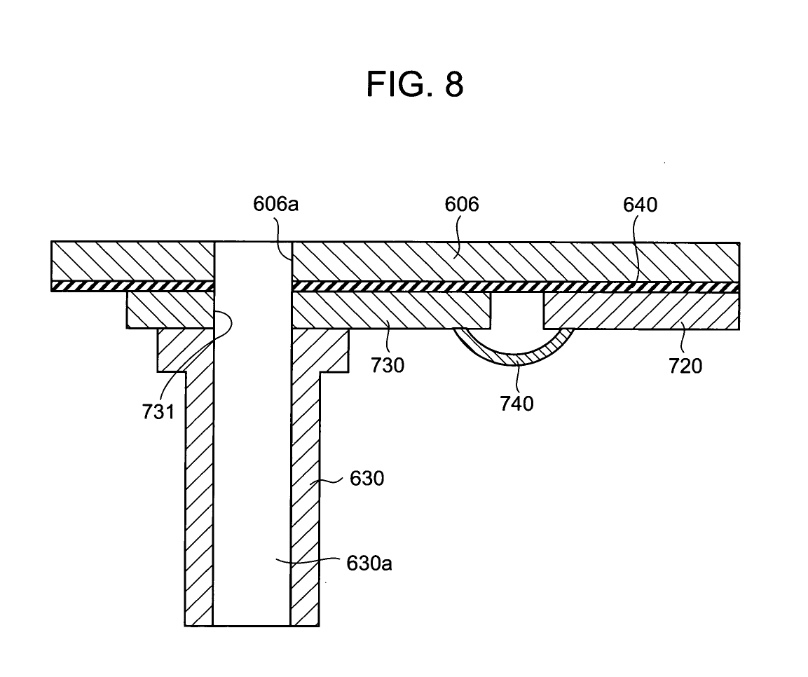

FIG. 8 is a sectional view taken along line VIII-VIII of FIG. 7.

As shown in FIGS. 7 and 8, in the second modification, after forming the heating wires 720 and 722 and the bonding layer 730 on the front surface of the insulating layer 640 in the state of being individually separated from each other, the heating wires 720 and 722 and the bonding layer 730 are bonded to each other with conductive wires 740, the heating wires 720 and 722 and the bonding layer 730 are electrically connected to each other through the wires 740. Each of the wires 740 may be composed of one wire or a plurality of wires.

### [Third Modification]

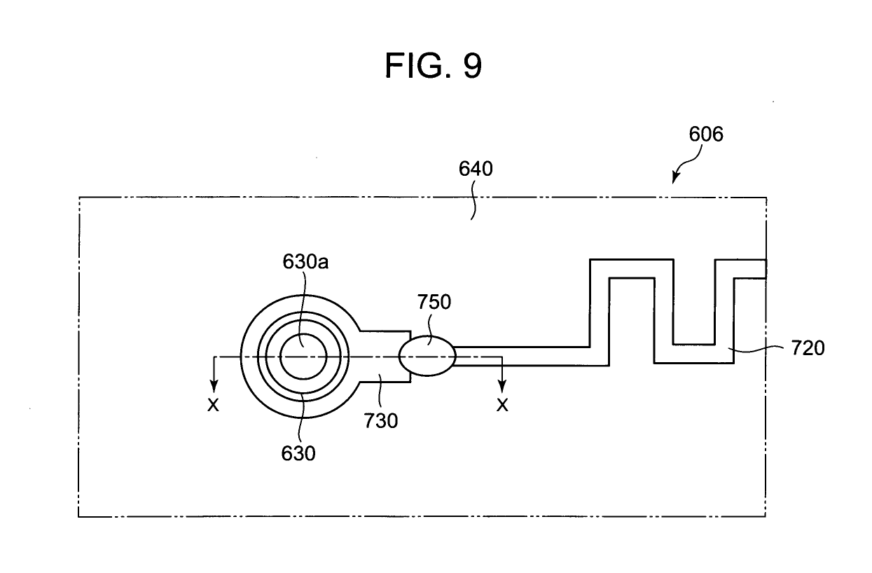

FIG. 9 is a plan view showing a third modification of the neighborhood of a joining area of a heating wire and a pipe member on the under surface of the micro-reactor module of the present embodiment.

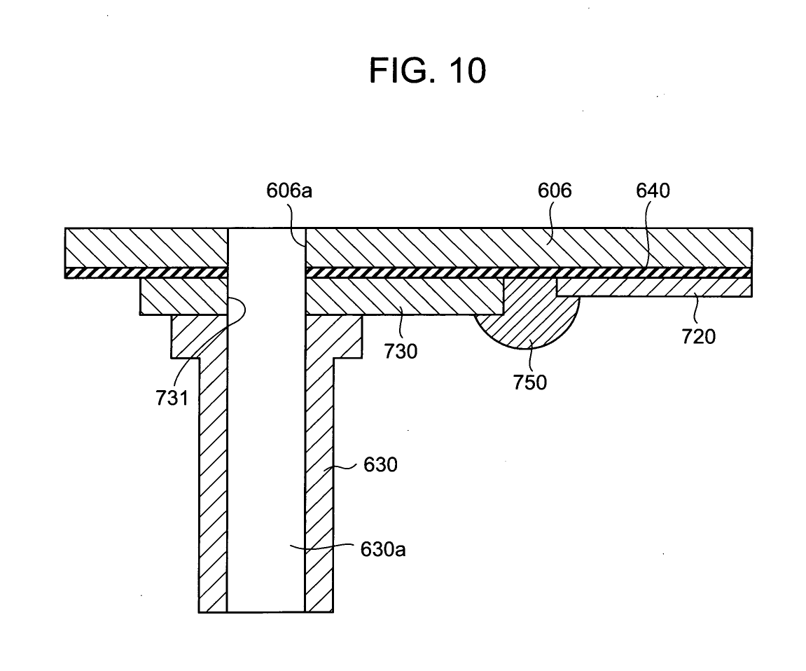

FIG. 10 is a sectional view taken along line X-X of FIG. 9.

As shown in FIGS. 9 and 10, in the third modification, after forming the heating wires 720 and 722 and the bonding layer 730 on the front surface of the insulating layer 640 in the state of being individually separated from each other, conductive brazing filler metals 750 are provided between each of the heating wires 720 and 722 and the bonding layer 730, and the heating wires 720 and 722 and the bonding layer 730 are electrically connected with each other through the brazing filler metals 750.

Next, the heat insulating package in the reaction apparatus of the present embodiment will be described.

As shown in FIG. 1, the micro-reactor module 600 is provided with the heat insulating package 791. The heat insulating package 791 is composed of a rectangular case 792, the under surface of which is open, and a plate 793 whose opening of the under surface of the case 792 is closed. The plate 793 is joined to the case 792 in the state in which the supply/discharge section 602 is inserted into holes 794 and 795 formed in the plate 793, and the high temperature reaction section 604, the low temperature reaction section 606 and the connection section 608 are housed in the heat insulating package 791.

The heat insulating package 791 reflects the heat radiation from the micro-reactor module 600 to suppress the propagation of heat to the outside of the heat insulating package 791. The internal space between the heat insulating package 791 and the micro-reactor module 600 is depressurized by a discharge so that the internal pressure may be 1 Pa or less, and is made to be a space for heat insulating. The supply/discharge section 602 is exposed from the heat insulating package 791, and is coupled to a generator unit 801, which will be described later.

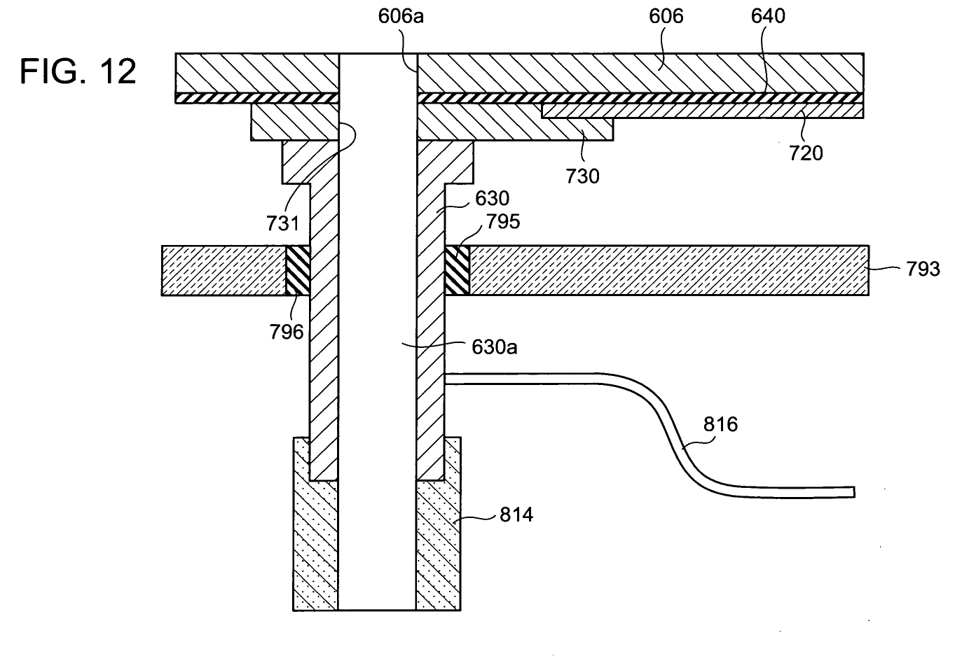

Lest the open air should enter the inside of the heat insulating package 791 through the holes 794 and 795, through which a liquid fuel introducing pipe 622 and the pipe members 626, 628, 630, 632, and 634 are inserted, to raise the internal pressure of the heat insulating package 791, the gaps between the liquid fuel introducing pipe 622 and the pipe members 626, 628, 630, 632, and 634, and the holes 794 and 795, respectively, are sealed with sealing media 796 in order to prevent the formation of the gaps (see FIG. 12).

If the heat insulating package 791 is made of a conductor, a glass material or an insulating sealing medium, which are insulators, are used as the sealing medium 796. On the other hand, if the heat insulating package 791 is made of an insulator such as ceramics, a metal wax, which is a conductor, can be used as the sealing medium 796 in addition to the glass material and the insulating sealing medium.

Next, a generator unit configured to include the micro-reactor module of the present embodiment will be described.

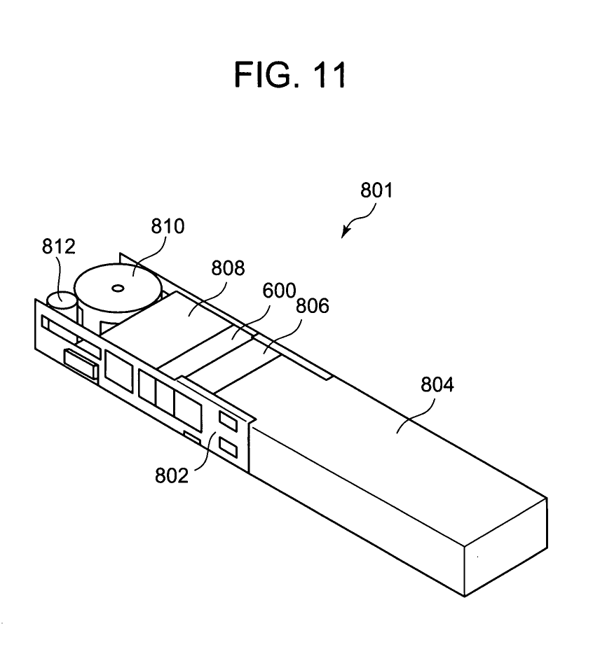

FIG. 11 is a perspective view showing an example of the generator unit including the micro-reactor module of the present embodiment.

As shown in FIG. 11, the micro-reactor module 600 described above can be used by being installed in the generator unit 801 in the sate of being housed in the heat insulating package 791. The generator unit 801, for example, includes: a frame 802; a fuel container 804 detachably attachable to the frame 802; a flow rate control section 806 including a flow path, a pump, a flow rate sensor, a valve, and the like; the micro-reactor module 600 in the state of being housed in the heat insulating package 791; a electric power generation cell 808 including a fuel cell, a humidifier, a collection unit, and the like; an air pump 810; and a power source section 812 including a secondary battery, a DC/DC converter, an external interface, and the like. A mixture gas of water and a liquid fuel in the fuel container 804 is supplied to the micro-reactor module 600 by the flow rate control section 806, and a hydrogen gas is consequently produced as described above. The hydrogen gas is then supplied to the fuel cell of the electric power generation cell 808, and the electricity produced by the electric power generation cell 808 is stored in the secondary battery of the power source section 812.

An example of the wiring structure of the installing part of the micro-reactor module 600 into the generator unit 801 will be described.

FIG. 12 is a sectional view showing a first example of the wiring structure of the installing part of the micro-reactor module to the generator unit in the present embodiment.

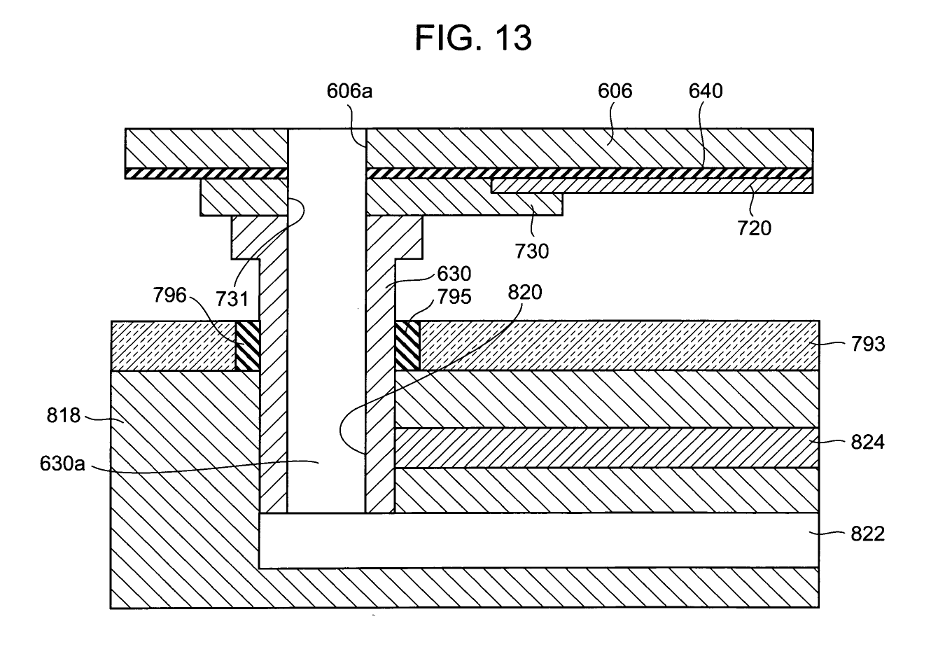

FIG. 13 is a sectional view showing a second example of the wiring structure of the installing part of the micro-reactor module to the generator unit in the present embodiment.

The wiring structure of the installing part of the micro-reactor module 600 into the generator unit 801 can be configured to be, for example, the structure shown in FIG. 12. That is, the pipe member 630 penetrating the base plate 793 is connected to a tube 814 provided in the generator unit 801. The tube 814 is made of, for example, an insulating material, such as silicon gum, and connects the pipe member 630 to a not shown flow path formed in the generator unit 801.

Similarly, the other pipe members 626, 628, 632, and 634 are enabled to supply a reactant from the generator unit 801 to the micro-reactor module 600 or to discharge a product from the micro-reactor module 600 by connecting a similar tube thereto.

Furthermore, a lead wire 816 is connected to the pipe members 626, 630, 632, and 634 other than the pipe member 628 in order to apply a voltage to the heating wires 720 and 722. The lead wire 816 is connected to a not shown control apparatus provided in the generator unit 801. The control apparatus applies a voltage between the pipe members 630 and 632 and between the pipe members 626 and 634 through the lead wires 816, as will be described later.

Incidentally, because the tubes connected to the pipe members 626, 628, 630, 632, and 634 are made of the insulating material, no currents flow through the other portions of the generator unit 801 when the voltages are applied between the pipe members 630 and 632 and between the pipe members 626 and 634.

Moreover, the interface of the generator unit 801 to which the micro-reactor module 600 is attached may be configured to be, for example, the structure shown in FIG. 13.

That is, on the side of the generator unit 801, insertion openings 820 for inserting pipe members 626, 628, 630, 632, and 634 are formed in an insulative base plate 818 abutting on the plate 793 of the heat insulating package 791. The insertion openings 820 are connected communicatively to flow paths 822 formed in the base plate 818. The insertion of the pipe members 626, 628, 630, 632 and 634 into the insertion openings 820 enables the supply of a reactant from the generator unit 801 to the micro-reactor module 600 and the discharge of a product from the micro-reactor module 600 through the flow paths 822.

Moreover, a terminal (not shown) touching the pipe member 630 is formed on the surfaces of the inner walls of the insertion openings 820 to which the pipe members 626, 630, 632, and 634 other than the pipe member 628 are inserted, respectively. The terminal are electrically connected to wiring 824 formed in the base plate 818, and the wiring 824 is connected to the not shown control apparatus provided in the generator unit 801. The control apparatus applies voltages between the pipe members 630 and 632 and between the pipe members 626 and 634 through the wiring 824 as will be described later.

Incidentally, because the terminal and the wiring 824 provided in the insertion openings 820 are provided on the insulative base plate 818, no currents flow through the other portions of the generator unit 801 when the voltages are applied between the pipe members 630 and 632 and between the pipe members 626 and 634.

In any of the structures mentioned above, the control apparatus measures the voltages applied to the heating wires 720 and 722 and the currents flowing through the heating wires 720 and 722 to measure the resistance values of the heating wires 720 and 722 as will be described later. Because the control apparatus stores the relations between the resistance values of the heating wires 720 and 722 and temperatures, the temperature of the micro-reactor module 600 can be measured based on the resistance values of the heating wires 720 and 722. The control apparatus then performs the feedback control of the voltages to be applied to the heating wires 720 and 722 to perform the temperature control of the micro-reactor module 600.

Next, the operation of the micro-reactor module 600 of the present embodiment will be described.

First, when voltages are applied between the pipe members 630 and 632 and between the pipe members 626 and 634, the heating wires 720 and 722 generate heat, and the low temperature reaction section 606, the high temperature reaction section 604, and the connection section 608 are heated. Incidentally, the currents and the voltages of the heating wires 720 and 722 are measured by the not shown control apparatus, and the temperatures of the liquid fuel introducing pipe 622, the high temperature reaction section 604, and the low temperature reaction section 606 are thereby measured. The measured temperatures are fed back to the control apparatus, and the voltages of the heating wires 720 and 722 are controlled by the control apparatus. Thereby, the temperature control of the micro-reactor module 600 is performed.

Next, in the state in which the micro-reactor module 600 is heated by the heating wires 720 and 722, the mixed liquid of a liquid fuel and water is continuously or intermittently supplied to the liquid fuel introducing pipe 622 by a pump or the like, and the liquid fuel is vaporized in the vaporizer 610. The vaporized mixture gas flows into the reformer 400 through the low temperature reaction section 606 and the connection section 608.

After that, the mixture gas is heated in the reformer 400 and a catalytic reaction of the mixture gas is produced. Thereby, a hydrogen gas and the like are produced (see the chemical reaction formulae (1) and (2) in the case where the fuel is methanol).

The mixture gas (including the hydrogen gas, a carbon dioxide gas, a carbon monoxide gas, and the like) produced in the reformer 400 flows into the carbon monoxide remover 500 through the connection section 608. On the other hand, air is supplied to the carbon monoxide remover 500 through the pipe member 634 by the pump or the like, and is mixed with the mixture gas of the hydrogen gas and the like. The carbon monoxide gas in the mixture gas is selectively oxidized in the carbon monoxide remover 500 to be removed.

The mixture gas in the state in which the carbon monoxide has been removed is supplied to the fuel electrode and the like of the fuel cell through the pipe member 626. In the fuel cell, electricity is generated by the electrochemical reaction of the hydrogen gas, and an offgas including an unreacted hydrogen gas and the like is discharged from the fuel cell.

The operation mentioned above is that of an early stage, and the mixed liquid is continuously supplied to the liquid fuel introducing pipe 622 also after that. Air is then mixed with the offgas discharged from the fuel cell, and the mixture gas (hereinafter referred to as a burning mixture gas) is supplied to the pipe member 632 and 628. The burning mixture gas supplied into the pipe member 632 flows into the first combustor 612, and is burned with a catalyst. Combustion heat is thereby generated, and the liquid fuel introducing pipe 622 and the low temperature reaction section 606 are heated by the combustion heat.

On the other hand, the burning mixture gas supplied to the pipe member 628 flows into the second combustor 614, and is burned with a catalyst. Combustion heat is thereby generated, and the reformer 400 is heated by the combustion heat.

The discharged gases of the catalytic combustion in the first combustor 612 and the second combustor 614 are discharged through the pipe member 630.

Incidentally, the configuration may be modified so that the liquid fuel reserved in the fuel container may be vaporized and the burning mixture gas of the vaporized fuel and air may be supplied to the pipe members 628 and 632.

In the state in which the mixed liquid is supplied to the liquid fuel introducing pipe 622 and the burning mixture gas is supplied to the pipe members 628 and 632, the control apparatus measures the temperatures of the heating wires 720 and 722 while controlling the voltages to be applied to the heating wires 720 and 722 and the pump and the like. When the pump is controlled by the control apparatus, the flow rates of the burning mixture gases to be supplied to the pipe members 628 and 632 are controlled, and the combustion heat quantities of the combustors 612 and 614 are controlled. The control apparatus controls the heating wires 720 and 722 and the pump in this way, and the temperature control of the liquid fuel introducing pipe 622, the high temperature reaction section 604, and the low temperature reaction section 606 is thereby performed. The temperature control is here performed so that the high temperature reaction section 604 may become 375° C. and the low. temperature reaction section 606 may be 150° C.

### [Electronic equipment]

Next, an example of an electronic equipment using the generator unit mentioned above as the power source thereof will be described.

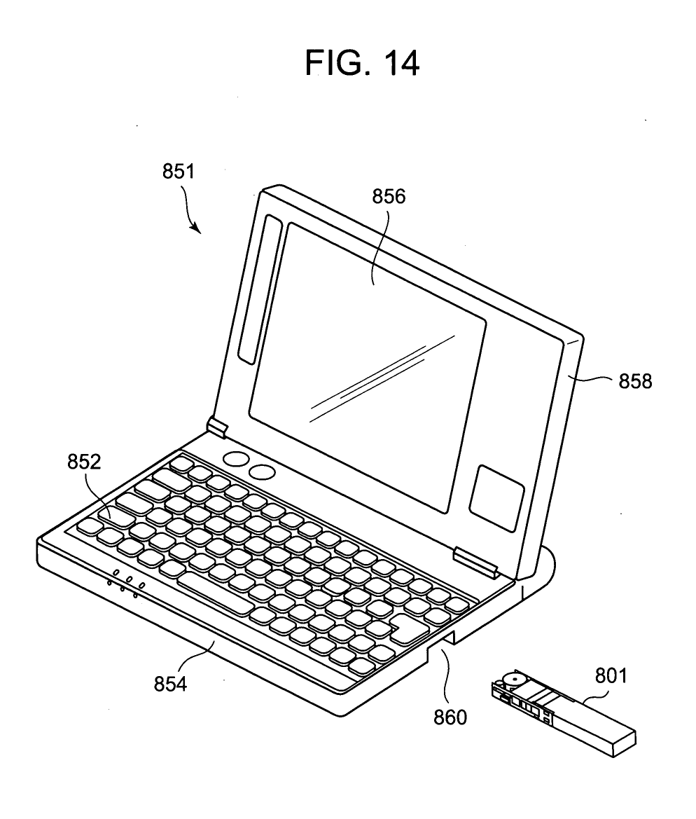

FIG. 14 is a perspective view showing an example of the electronic equipment using the generator unit as the power source thereof.

The electronic equipment 851 is a portable electronic equipment, and is especially a notebook computer. The electronic equipment 851 incorporates an operation processing circuit composed of a CPU, a RAM, a ROM, and other electronic components, and includes a lower housing 854 equipped with a keyboard 852 and an upper housing 858 equipped with a liquid crystal display 856. The lower housing 854 and the upper housing 858 are combined with each other with hinges, and are configured so that it is possible to fold the upper housing 858 over the lower housing 854 with the liquid crystal display 856 being opposed to the keyboard 852. A mounting portion 860 for mounting the generator unit 801 is formed to be a concave part at a position from the right side surface of the lower housing 854 to the bottom surface thereof. When the generator unit 801 is mounted into the mounting portion 860, the electronic equipment 851 is operated by the electricity of the generator unit 801.

Incidentally, the present invention is not limited to the above embodiment, and various improvements and changes of the design thereof can be performed without departing from the scope of the present invention.

For example, although the two pipe members are connected to both the ends of the heating wire in the above embodiment, the present invention is not limited to such a configuration, but, for example, the other electric wiring of a vacuum sensor and the like may be further provided in the heat insulating package, and any two pipe members may be connected to the electric wiring.

### Second Embodiment

Next, a second embodiment of the reaction apparatus according to the present invention will be described.

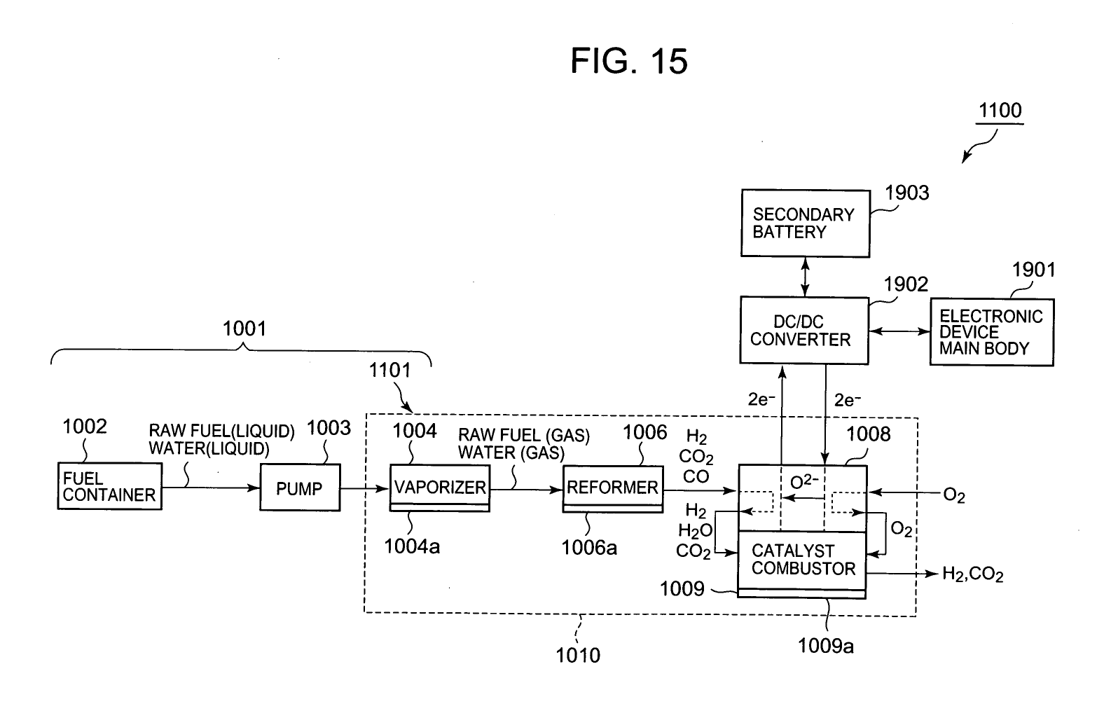

FIG. 15 is a block diagram showing the configuration of an electronic equipment to which a second embodiment of the reaction apparatus according to the present invention is applied.

The electronic equipment 1100 shown in FIG. 15 is a portable electronic equipment such as a notebook computer, a PDA, an electronic organizer, a digital camera, a portable telephone, a wrist watch, a register, or a projector.

The electronic equipment 1100 includes: a fuel cell apparatus 1001 composed of a reaction apparatus 1101, a fuel container 1002, and a pump 1003 in the present embodiment; a DC/DC converter 1902; a secondary battery 1903; and an electronic equipment main body 1901.

The fuel container 1002 of the fuel cell apparatus 1001 is provided to the electronic equipment 1100, for example, to be detachably attachable, and the pump 1003 and the reaction apparatus 1101 are, for example, built in the main body of the electronic equipment 1100.

The fuel container 1002 reserves a mixed liquid of a liquid raw fuel (such as methanol, ethanol, or dimethyl ether) and water. Incidentally, the liquid raw fuel and the water may be reserved in separate containers.

The pump 1003 sucks the mixed liquid in the fuel container 1002 to send the liquid to a vaporizer 1004 in the reaction apparatus 1101.

The reaction apparatus 1101 is provided with a box-like heat insulating package 1010, and the vaporizer 1004, a reformer 1006, an electric power generation cell 1008, and a catalyst combustor 1009 are house in the heat insulating package 1010. The barometric pressure in the heat insulating package 1010 is kept to be a vacuum pressure (for example, 10 Pa or less) lower than the atmospheric pressure.

Electric heater/temperature sensors 1004a, 1006a, and 1009a are provided in the vaporizer 1004, the reformer 1006, and the catalyst combustor 1009, respectively. Because the electric resistance values of the electric heater/temperature sensors 1004a, 1006a, and 1009a severally depend on the temperature, the electric heater/temperature sensors 1004a, 1006a, and 1009a also function as temperature sensors measuring the temperatures of the vaporizer 1004, the reformer 1006, and the catalyst combustor 1009, respectively.

The mixed liquid sent from the pump 1003 to the vaporizer 1004 is heated to a temperature within a range of from about 110° C. to about 160° C. by the heat of the electric heater/temperature sensor 1004a and the catalyst combustor 1009, and is vaporized. The mixture gas vaporized in the vaporizer 1004 is sent to the reformer 1006.

In the inside of the reformer 1006 a flow path is formed, and a catalyst is held on the wall surface of the flow path. The mixture gas sent from the vaporizer 1004 to the reformer 1006 flows through the flow path of the reformer 1006, and is heated to a temperature within a range of from about 300° C. to about 400° C. by the heat of the electric heater/temperature sensor 1006a and the catalyst combustor 1009 to cause a reaction by the catalyst. A mixture gas (reformed gas) of hydrogen and carbon dioxide, both as a fuel, infinitesimal carbon monoxide, as a by-product, and the like are produced by a catalytic reaction of a raw fuel and water.

Incidentally, if the raw fuel is methanol, the steam reforming reaction as expressed by the formula (1) mentioned above is mainly caused in the reformer 1006. Moreover, carbon monoxide is infinitesimally produced as a by-product by the reaction expressed by the following formula (3), which is sequentially caused subsequently to the chemical reaction formula (1):

H₂+CO₂→H₂O+CO (3).

The produced reformed gas is sent out to the electric power generation cell 1008.

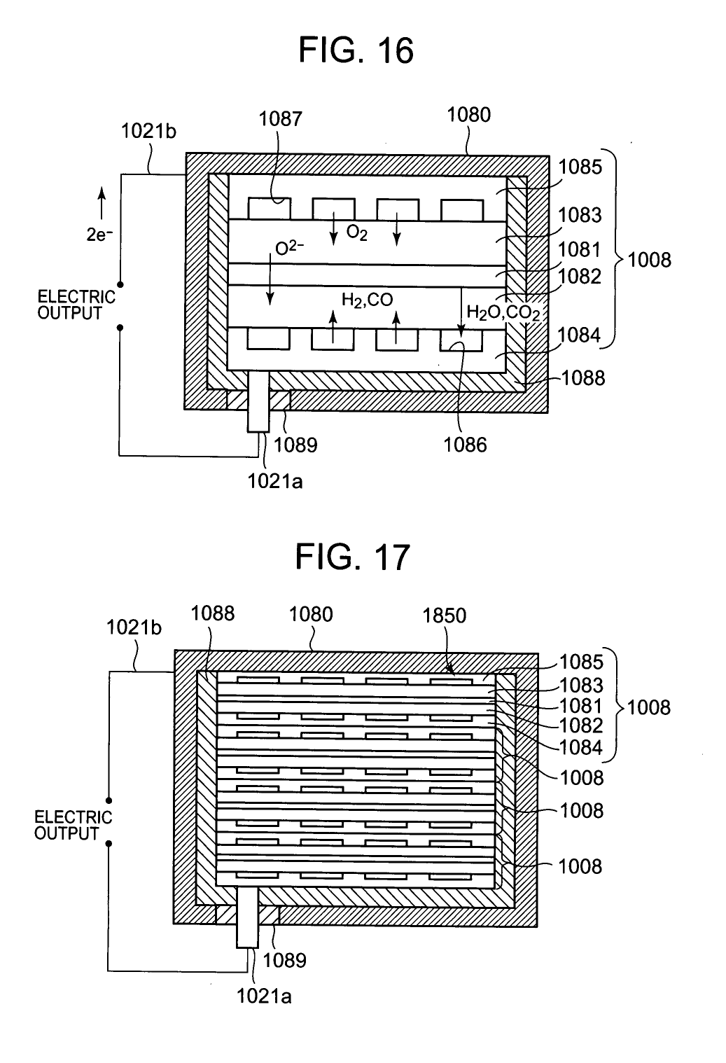

FIG. 16 is a schematic view of an electric power generation cell in the present embodiment.

FIG. 17 is a schematic view showing an example of an electric power generation cell stack.

The electric power generation cell 1008 is housed in a housing 1080, and includes a solid oxide electrolyte 1081, a fuel electrode 1082 (anode), an oxygen electrode 1083 (cathode), both formed on both the surfaces of the solid oxide electrolyte 1081, an anode collector electrode 1084, which is joined with the fuel electrode 1082 and forms a flow path 1086 on the joint surface, and a cathode collector electrode 1085, which is joined with the oxygen electrode 1083 and forms a flow path 1087 on the joint surface.

Incidentally, only the cathode collector electrode 1085 touches the housing 1080 and the other oxygen electrode 1083, solid oxide electrolyte 1081, fuel electrode 1082, and anode collector electrode 1084 are insulated from the housing 1080 with an insulating material 1088 such as ceramics.

(Zr₁₋ₓYₓ)O_{2-x/2}(YSZ) in zirconia series, (La₁₋ₓSrₓ)(Ga_{1-y-z}Mg_{y}Co_{z})O₃ in lanthanum gallate series, and the like can be used as the solid oxide electrolyte 1081; La_{0.84}Sr_{0.16}MnO₃, La(Ni, Bi)O₃, (La, Sr)MnO₃, In₂O₃+SnO₂, LaCoO₃, and the like can be used as the fuel electrode 1082; Ni, In+YSZ, and the like can be used as the oxygen electrode 1083; and LaCr(Mg)O₃, (La, Sr)CrO₃, NiAl+Al₂O₃, and the like can be used as the anode collector electrode 1084 and the cathode collector electrode 1085.

The electric power generation cell 1008 is heated by the electric heater/temperature sensor 1009a and the heat of the catalyst combustor 1009 to a temperature within a range of from about 500° C. to about 1000° C., and a reaction, which will be described later, is caused.

Air is sent to the oxygen electrode 1083 through the flow path 1087 of the cathode collector electrode 1085.

The oxygen electrode 1083 produces oxygen ions using oxygen and electrons supplied from a cathode output electrode 1021b as shown in the following formula (4):

O₂+4e⁻→2O²⁻ (4).

The solid oxide electrolyte 1081 has the transparency of oxygen ions, and allows the oxygen ions produced by the oxygen electrode 1083 to transmit the solid oxide electrolyte 1081 to reach the fuel electrode 1082.

The reformed gas sent out from the reformer 1006 is sent to the fuel electrode 1082 through the flow path 1086 of the anode collector electrode 1084. At the oxygen electrode 1083, the reactions expressed by the following formulae (5) and (6) of the oxygen ions transmitted through the solid oxide electrolyte 1081 and the reformed gas are caused:

H₂+O²⁻→H₂O+2e⁻ (5), and

CO+O²⁻→CO₂+2^{e-} (6).

The anode collector electrode 1084 is connected to an anode output electrode 1021a, and the cathode collector electrode 1085 is electrically connected to the cathode output electrode 1021b, as will be described later. The anode output electrode 1021a and the cathode output electrode 1021b are connected to the DC/DC converter 1902. The electrons produced by the fuel electrode 1082 are consequently supplied to the cathode collector electrode 1085 from the housing 1080 through the anode output electrode 1021a, external circuits such as the DC/DC converter 1902, and the cathode output electrode 1021b, as will be described later.

Incidentally, as shown in FIG. 17, a plurality of the electric power generation cells 1008, each composed of the anode collector electrode 1084, the fuel electrode 1082, the solid oxide electrolyte 1081, the oxygen electrode 1083, and the cathode collector electrode 1085, may be connected to each other in series to form a fuel cell stack 1850.

In this case, as shown in FIG. 17, only the anode collector electrode 1084 at one end of the serially connected electric power generation cells 1008 is abutted on the anode output electrode 1021a, and only the cathode collector electrode 1085 at the other end of the electric power generation cells 1008 is abutted on the housing 1080.

The DC/DC converter 1902 converts the electrical energy generated by the electric power generation cell 1008 into a suitable voltage, and then supplied the converted voltage to the electronic equipment main body 1901. Moreover, the DC/DC converter 1902 charges the electrical energy generated by the electric power generation cell 1008 into the secondary battery 1903, and supplies the electrical energy stored in the secondary battery 1903 to the electronic equipment main body 1901 when the electric power generation cell 1008 does not operate.

The reformed gas (offgas) passed through the flow path of the anode collector electrode 1084 also includes unreacted hydrogen. The offgas is supplied to the catalyst combustor 1009.

The air passed through the flow path 1087 of the cathode collector electrode 1085 is also supplied to the catalyst combustor 1009 together with the offgas. A flow path is formed in the catalyst combustor 1009, and a Pt series catalyst is held on the wall surface of the flow path.

The catalyst combustor 1009 is provided with the electric heater/temperature sensor 1009a made of an electrical heating material. Because the electric resistance value of the electric heater/temperature sensor 1009a depends on a temperature, the electric heater/temperature sensor 1009a also functions as a temperature sensor measuring the temperature of the catalyst combustor 1009.

The mixture gas (combustion gas) of the offgas and the air flows through the flow path of the catalyst combustor 1009, and is heated by the electric heater/temperature sensor 1009a. The hydrogen in the combustion gas flowing through the flow path of the catalyst combustor 1009 is burned by the catalyst, and combustion heat is thereby generated. The discharged gas after burning is discharged from the catalyst combustor 1009 to the outside of the heat insulating package 1010.

The combustion heat generated in the catalyst combustor 1009 is used to keep the temperature of the electric power generation cell 1008 at a high temperature (from about 500° C. to about 1000° C.). The heat of the electric power generation cell 1008 is then conducted to the reformer 1006 and the vaporizer 1004, and is used for the vaporization in the vaporizer 1004 and the steam reforming reaction in the reformer 1006.

Next, the concrete configuration of the reaction apparatus 1101 will be described.

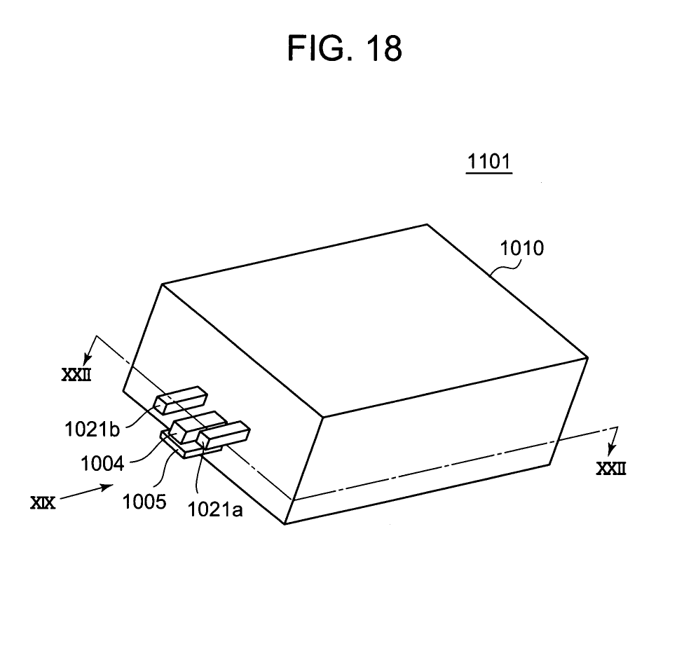

FIG. 18 is a perspective view of the reaction apparatus in the present embodiment.

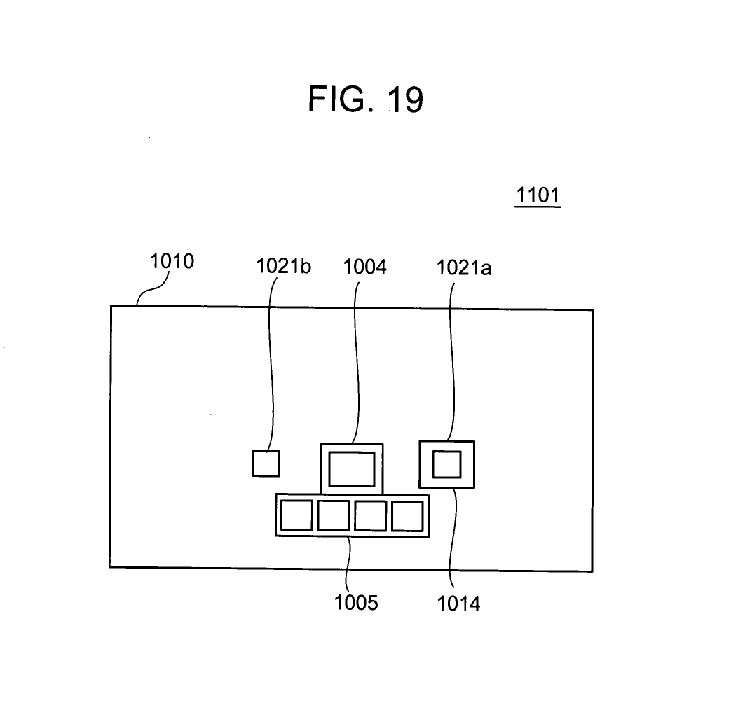

FIG. 19 is a side view looked from the arrow XIX direction in FIG. 18.

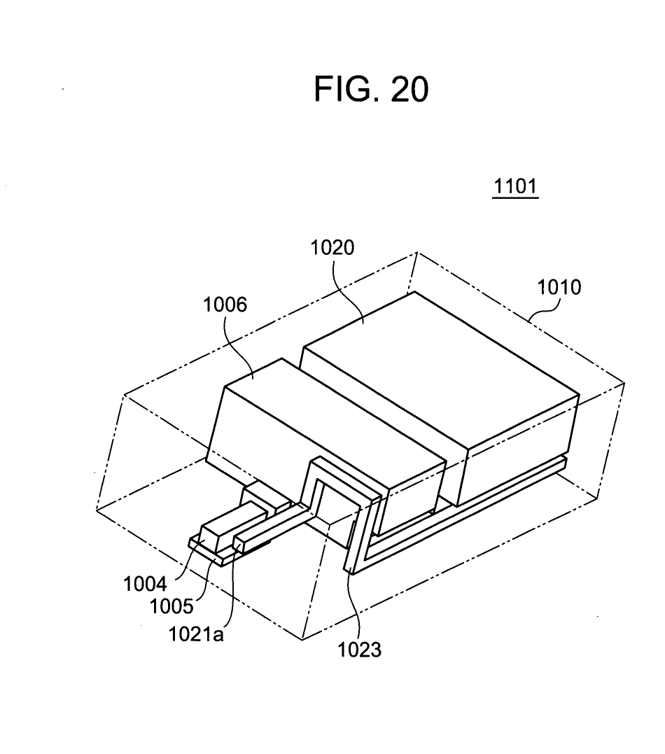

FIG. 20 is a perspective view showing the internal structure of the heat insulating package of the reaction apparatus in the present embodiment.

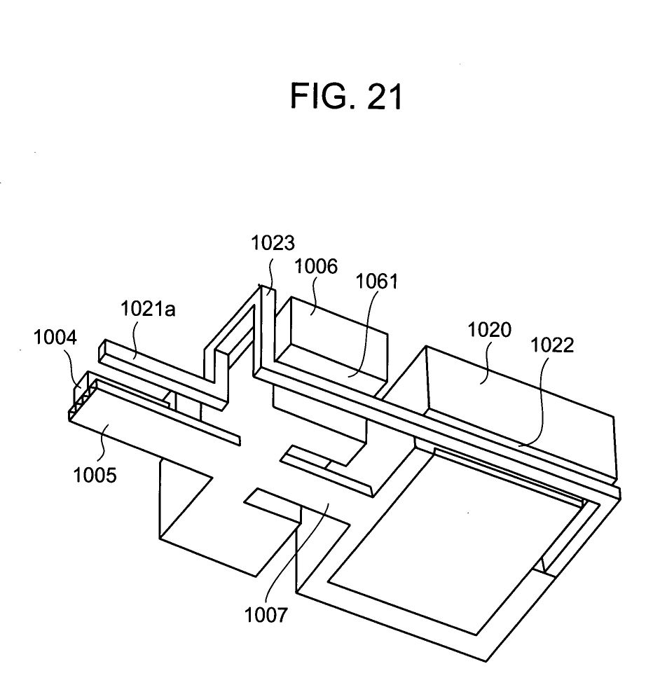

FIG. 21 is a perspective view of the internal structure of the reaction apparatus of FIG. 20 when it is looked from the under side thereof.

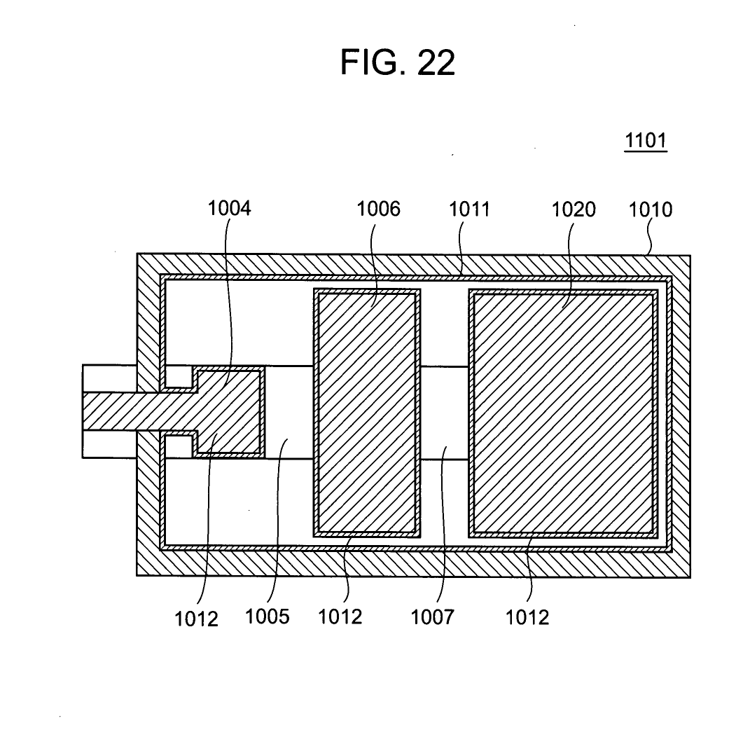

FIG. 22 a sectional view taken along line XXII-XXII of FIG. 18.

As shown in FIG. 18, the inlet of the vaporizer 1004, a connection section 1005, and the anode output electrode 1021a penetrate one wall surface of the heat insulating package 1010 of the reaction apparatus 1101, and the cathode output electrode 1021b projects from the same wall surface.

As shown in FIGS. 20-22, the vaporizer 1004 and the connection section 1005, the reformer 1006, a connection section 1007, and a fuel cell section 1020 are arranged in the order in the heat insulating package 1010 of the reaction apparatus 1101. Incidentally, the fuel cell section 1020 is composed of the housing 1080 housing the electric power generation cell 1008 and the catalyst combustor 1009, both being integrally formed, and the offgas is supplied from the fuel electrode 1082 of the electric power generation cell 1008 to the catalyst combustor 1009.

Each of the vaporizer 1004, the connection section 1005, the reformer 1006, the connection section 1007, the fuel housing 1080 housing the electric power generation cell 1008 and the catalyst combustor 1009 of the fuel cell section 1020, the heat insulating package 1010, the anode output electrode 1021a, and the cathode output electrode 1021b is made of a metal having high temperature durability and a moderate heat conductance, and can be formed by using, for example, a Ni series alloy inconel such as inconel 783.

A radiation reducing film 1011 is formed on the surface of the inner wall of the heat insulating package 1010, and a radiation reducing film 1012 is formed on each of the surfaces of the outer walls of the vaporizer 1004, the connection section 1005, the reformer 1006, the connection section 1007, and the fuel cell section 1020. The radiation reducing films 1011 and 1012 prevent the heat transfer caused by radiation, and, for example, Au, Ag, and the like can be used as the radiation reducing films 1011 and 1012. It is preferable that at least either of the radiation reducing films 1011 and 1012 is provided, and it is more preferable that both of them are provided.

The vaporizer 1004 penetrates the wall surface of the heat insulating package 1010 together with the connection section 1005, and the vaporizer 1004 and the reformer 1006 are connected with each other with the connection section 1005. The reformer 1006 is connected with the fuel cell section 1020 with the connection section 1007.

As shown in FIGS. 20 and 21, the vaporizer 1004, the connection section 1005, the reformer 1006, the connection section 1007, and the fuel cell section 1020 are integrally formed, and the under surfaces of the connection section 1005, the reformer 1006, the connection section 1007, and the fuel cell section 1020 are formed to be flush with each other.

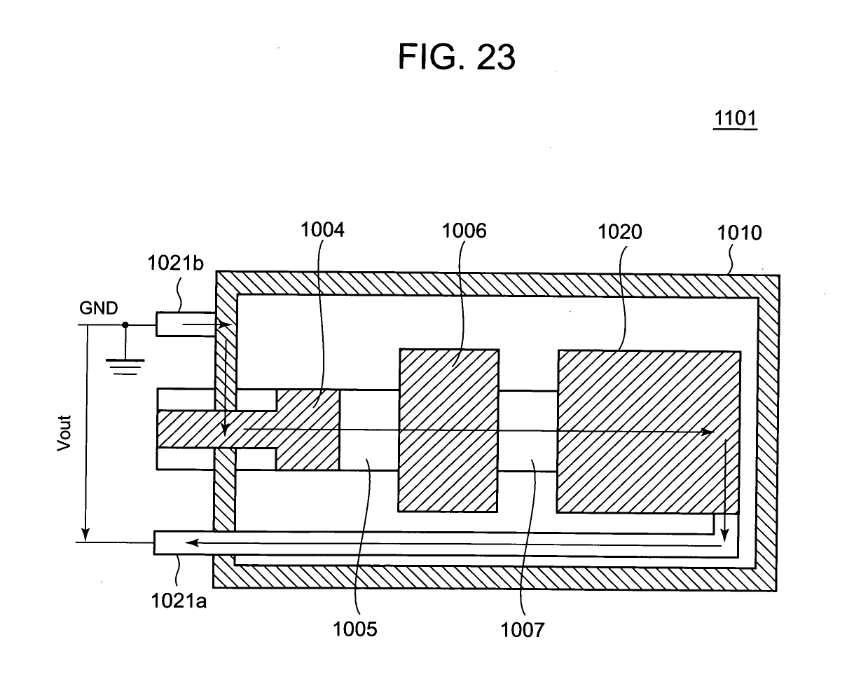

FIG. 23 is a schematic view showing how electrons flow in the reaction apparatus of the present embodiment.

As shown in FIG. 23, the electrons are supplied from the cathode collector electrode 1085 to the oxygen electrode 1083 through the heat insulating package 1010 electrically connected with the cathode output electrode 1021b, the connection section 1005 and the vaporizer 1004, the reformer 1006, the connection section 1007, and the housing 1080 of the fuel cell section 1020. On the other hand, the electrons produced at the fuel electrode 1082 are output to the outside through the anode output electrode 1021a.

The cathode output electrode 1021b is connected to the ground (GND), the potential difference (Vout) of the potential of the anode output electrode 1021a to that of the cathode output electrode 1021b is the output voltage of the electric power generation cell 1008.

Incidentally, the heat insulating package 1010, and the vaporizer 1004 and the connection section 1005 that project from the heat insulating package 1010 may be used as the output electrodes on the cathode side as they are without separately providing the cathode output electrode 1021b.

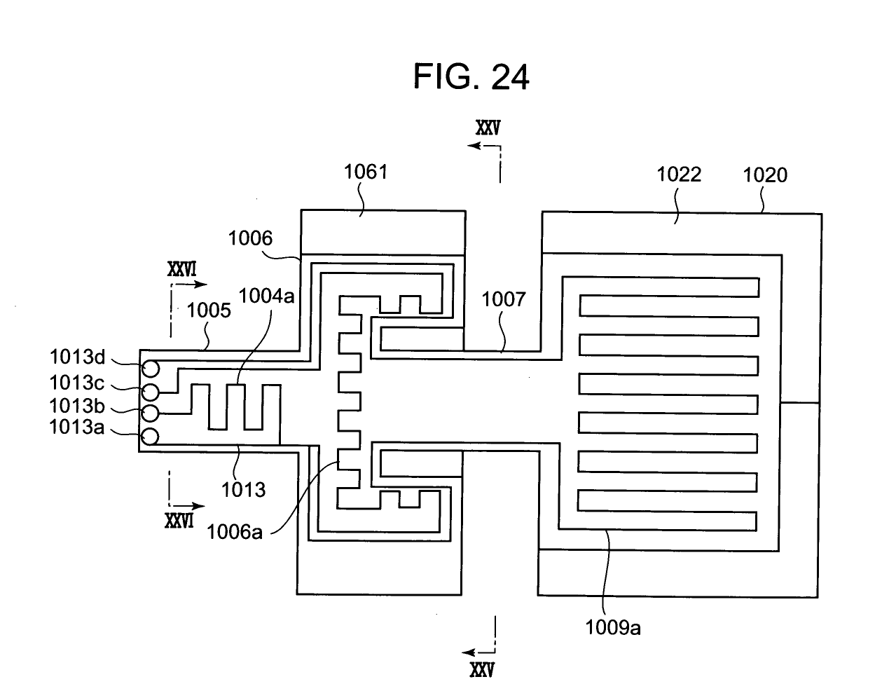

FIG. 24 is a view of the under surfaces of the connection sections, the reformer, and the fuel cell section in the reaction apparatus of the present embodiment.

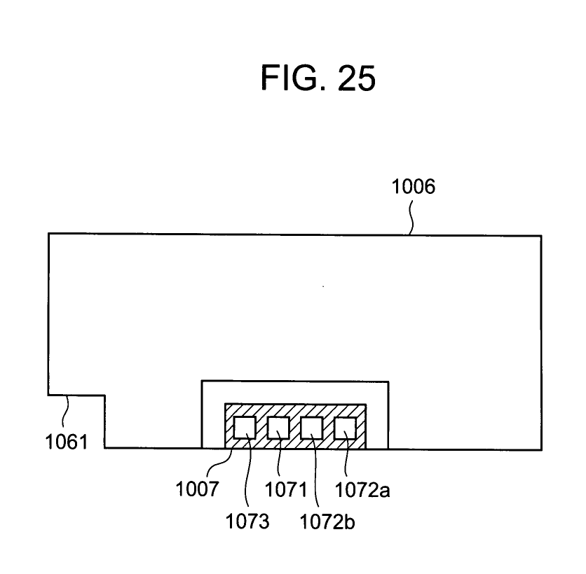

FIG. 25 is a sectional view taken along line XXV-XXV of FIG. 24.

Incidentally, in FIGS. 24 and 25, the anode output electrode 1021a and the cathode output electrode 1021b are omitted.

As shown in FIGS. 24 and 25, concave portions 1061 and 1022 for arranging the anode output electrode 1021a are formed on the outer edge of the under side of the reformer 1006 and the fuel cell section 1020.

Moreover, the portion of the reformer 1006 at which the reformer 1006 is connected to the connection section 1007 recedes from the surface opposed to the fuel cell section 1020. The apparatus can be accordingly miniaturized by shortening the distance between the fuel cell section 1020 and the reformer 1006 while lengthening the connection section 1007 to reduce the heat conduction from the fuel cell section 1020 to the reformer 1006.

As shown in FIG. 24, a wiring pattern 1013 is formed on the under surfaces of the connection section 1005, the reformer 1006, the connection section 1007, and the fuel cell section 1020 after performing insulation processing to the under surfaces with ceramics or the like.

The wiring pattern 1013 is formed in a winding state on the lower parts of the vaporizer 1004, the reformer 1006, and the fuel cell section 1020 to be the electric heater/temperature sensors 1004a, 1006a, and 1009a, respectively. One ends of the electric heater/temperature sensors 1004a, 1006a, and 1009a are connected to a common terminal 1013a, and the other ends thereof are connected to independent three terminals 1013b, 1013c, and 1013d, respectively. These four terminals 1013a, 1013b, 1013c, and 1013d are formed at the end of the connection section 1005 on the side outer than that of the heat insulating package 1010.

Incidentally, insulation processing is formed at the part where the connection section 1005 penetrates the heat insulating package 1010 lest the electric heater/temperature sensors 1004a, 1006a, and 1009a should be electrically connected to the heat insulating package 1010.

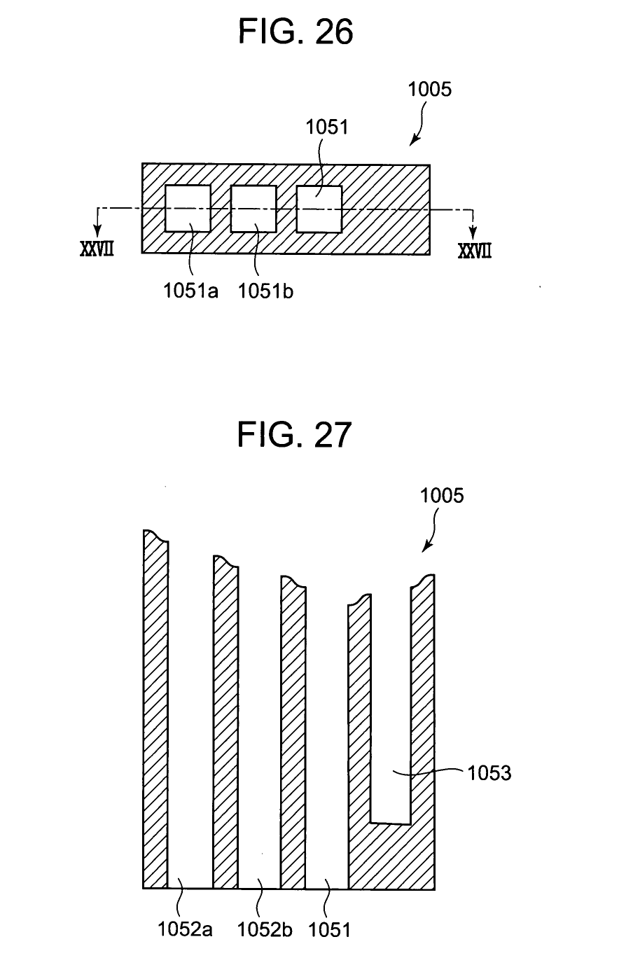

FIG. 26 is a sectional view taken along line XXVI-XXVI of FIG. 24.

FIG. 27 is a sectional view taken along line XXVII-XXVII of FIG. 26.

Supply flow paths 1051 and 1071 of the air to be supplied to the oxygen electrode 1083 of the electric power generation cell 1008 and discharge flow paths 1052a, 1052b, 1072a, and 1072b of the discharged gas to be discharged from the catalyst combustor 1009 are formed in the connection sections 1005 and 1007. Moreover, a supply flow path 1053 of the gaseous fuel sent out from the vaporizer 1004 to the reformer 1006 is formed in the connection section 1005, and a supply flow path 1073 of the reformed gas sent out from the reformer 1006 to the fuel electrode 1082 of the electric power generation cell 1008 is formed in the connection section 1007.

Incidentally, as shown in FIG. 25, four flow paths 1071, 1072a, 1072b, and 1073 are formed in the inside of the connection section 1007. In order to sufficiently enlarge the diameter of the flow path of the discharged gas discharged from the catalyst combustor 1009 to the offgas and the air supplied to the catalyst combustor 1009, two of the four flow paths are used as the flow paths 1072a and 1072b of the discharged gas from the catalyst combustor 1009, and the other two are used as the supply flow path 1073 of the reformed gas to the fuel electrode 1082 of the electric power generation cell 1008 and the supply flow path 1071 of the air to the oxygen electrode 1083 .

The anode output electrode 1021a is connected at the position of the fuel cell section 1020 where the distance between the position and the wall surface of the heat insulating package 1010 to which the anode output electrode 1021a penetrates is larger than the distance between the connection section 1007 and the wall surface, and the anode output electrode 1021a is preferably connected to the end opposite to the connection section 1007 to be pulled out.

As shown in FIGS. 16 and 17, the anode output electrode 1021a penetrates the housing 1080 to be pulled out from the anode collector electrode 1084. Incidentally, the portion between the anode output electrode 1021a and the housing 1080 is sealed with an insulating material 1089, such as glass or ceramics.

The anode output electrode 1021a is arranged along the concave portions 1022 and 1061 of the fuel cell section 1020 and the reformer 1006, respectively, and is bent in the space between the surface of the inner wall of the heat insulating package 1010 and the reformer 1006 as shown in FIGS. 20 and 21. The bent portion 1023 fulfills the role of a stress relaxation structure of the stress caused by the deformation of the anode output electrode 1021a between the fuel cell section 1020 and the heat insulating package 1010.

The end of the anode output electrode 1021a projects to the outside from the same wall surface as that of the heat insulating package 1010 where the inlet of the vaporizer 1004 and the connection section 1005 project. Incidentally, the portion between the anode output electrode 1021a and the heat insulating package 1010 is sealed with an insulative sealing material 1014, such as frit glass, as shown in FIG. 19.

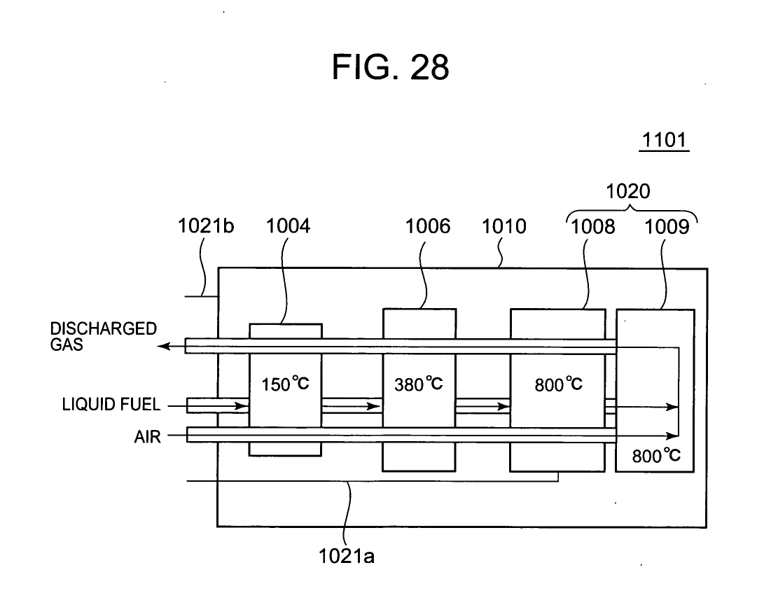

FIG. 28 is a schematic view showing a temperature distribution in the heat insulating package in the reaction apparatus of the present embodiment at the time of a steady state operation.

As shown in FIG. 28, for example, if the fuel cell section 1020 is kept at about 800° C., then heat moves from the fuel cell section 1020 to the reformer 1006 through the connection section 1007, and from the reformer 1006 to the vaporizer 1004 through the connection section 1005. Then the heat moves to the outside of the heat insulating package 1010. As a result, the reformer 1006 is kept at about 380° C., and the vaporizer 1004 is kept at about 150° C.

Moreover, the heat of the fuel cell section 1020 moves to the outside of the heat insulating package 1010 also through the anode output electrode 1021a. The anode output electrode 1021a expands after a start of the fuel cell apparatus 1001 owing to a temperature rise.

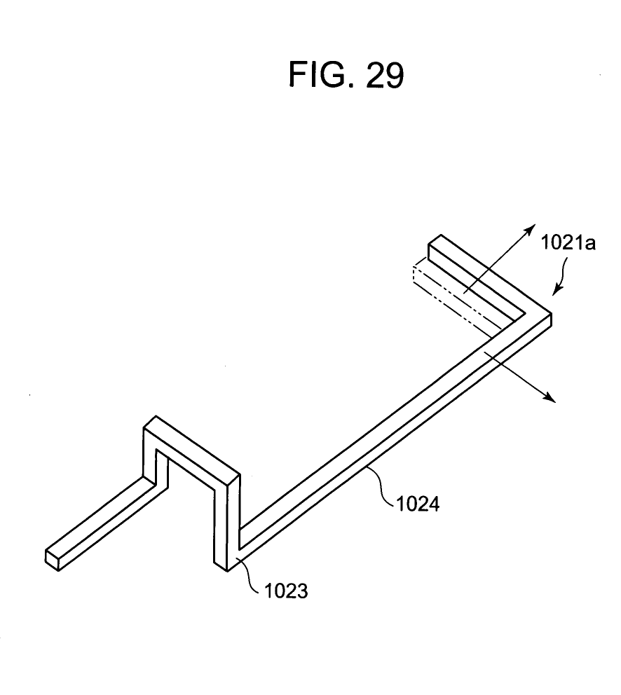

FIG. 29 is a simulation view showing a deformed state of the anode output electrode 1021a in the reaction apparatus of the present embodiment owing to a temperature rise.

The anode output electrode 1021a swells owing to a temperature rise of the fuel cell section 1020, and is deformed from the shape shown by an alternate long and two short dashes line in FIG. 29 to the shape shown by a solid line in the same figure.

At this time, because the temperature of a portion 1024 of the anode output electrode 1021a on the fuel cell section 1020 side is higher than that of the bent portion 1023, the portion 1024 expands larger. Because the anode output electrode 1021a is configured so that one end thereof is connected to the anode collector electrode 1084 of the fuel cell section 1020 and the other end thereof is joined to the wall surface of the heat insulating package 1010 on the vaporizer 1004 side to project to the outside, the anode output electrode 1021a receives the stress produced by the expansion. Because the anode output electrode 1021a, however, includes the bent portion 1023, the deformation caused by the expansion can be absorbed by the bent portion 1023. Consequently, the stress operating between the heat insulating package 1010 and the fuel cell section 1020 can be relaxed.

Moreover, because the cathode output electrode connected to the cathode collector electrode 1085 can be omitted by using a conductor for the vaporizer 1004, the connection section 1005, the reformer 1006, the connection section 1007, and the housing 1080 to substitute them for the output electrode connected to the cathode collector electrode 1085, the routes of heat transfers can be decreased, and the heat loss discharged from the fuel cell section 1020 to the heat insulating package 1010 can be reduced. Furthermore, because the provision of the bent portion 1023 lengthens the heat transfer route through the anode output electrode 1021a, the heat loss discharged from the fuel cell section 1020 to the heat insulating package 1010 through the anode output electrode 1021a can be reduced more.

Next, the modifications of the internal structure of the heat insulating package of the reaction apparatus of the present embodiment will be described.

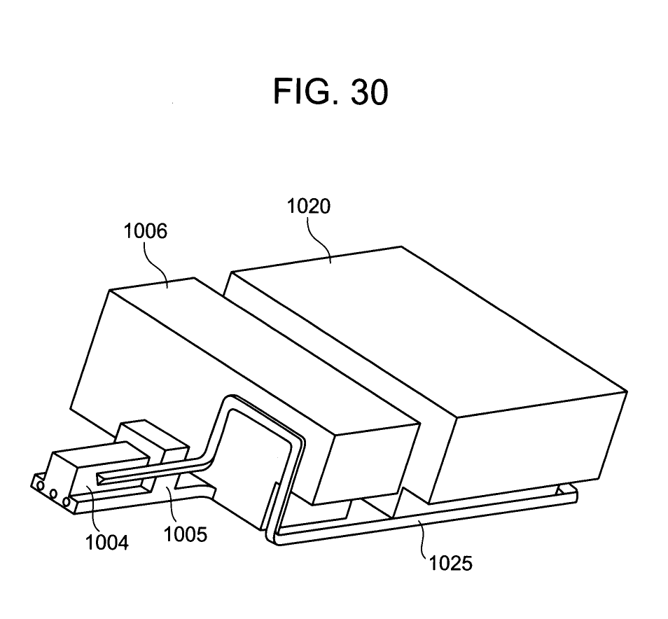

FIGS. 30, 31, and 32 are perspective views severally showing a modification of the internal structure of the heat insulating package of the reaction apparatus of the present embodiment.

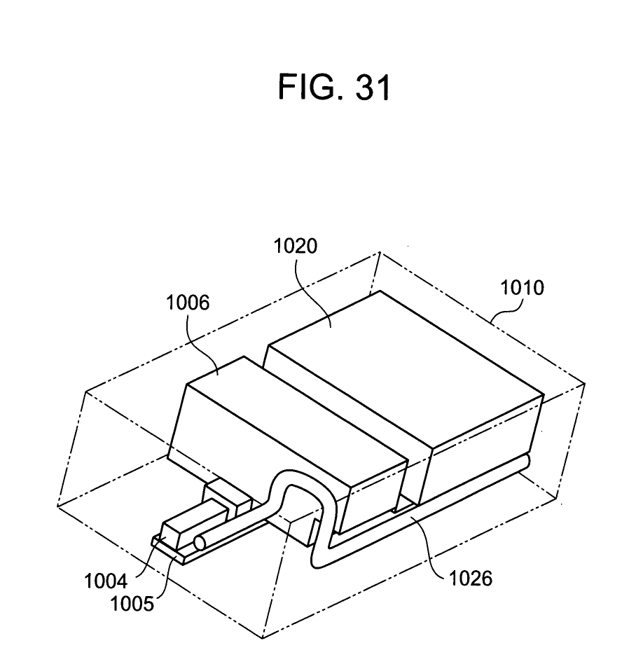

Although the configuration uses the anode output electrode 1021a having the sectional shape of a quadrilateral in the above embodiment, an anode output electrode 1025 having the sectional shape of a triangle may be used, for example, as shown in FIG. 30. Moreover, as shown in FIG. 31, an anode output electrode 1026 having the sectional shape of a circle may be used.

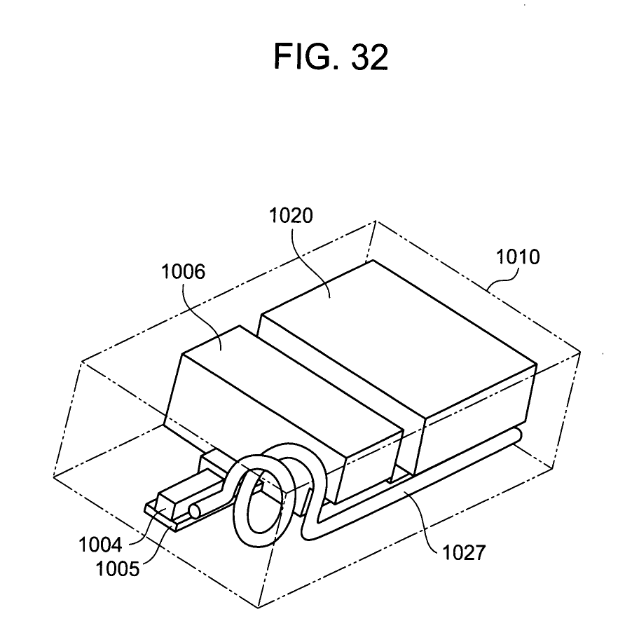

Moreover, the anode output electrode 1021a is bent at a right angle at three positions in the bent portion 1023 as the stress relaxation structure in the above embodiment as shown in FIGS. 20 and 21, but as shown in FIGS. 30 and 31 the bent parts in the bent portion may be formed in arcs to be smoothly bent. In this case, the concentration of stress to the bent portions can be suppressed to be dispersed to the whole bent portion, and the breakage caused by the stress can be suppressed. Alternatively, an anode output electrode 1027 including a stress relaxation structure formed in a coil in a space between the surface of the inner wall of the heat insulating package 1010 and the reformer 1006 may be used as shown in FIG. 32.

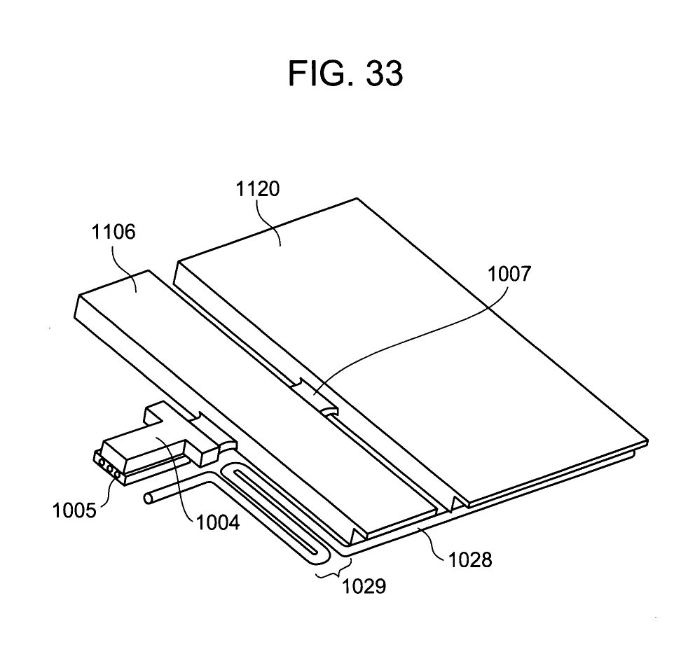

Moreover, if a vaporizer 1104, a reformer 1106, and a fuel cell section 1120 that are formed to be thinner in order to form the heat insulating package 1010 to be thinner, an anode output electrode 1028 forming the bent portion 1029 thereof in a winding shape as shown in FIG. 33 may be used.

All of the disclosures including the patent specification, the claims, the attached drawings and the abstract of Japanese Patent Application No. 2006-183402 filed Jul. 3, 2006 and of Japanese Patent Application No. 2006-263053 filed Sep. 27, 2006 are herein incorporated by reference.

Although various typical embodiments have been shown and described, the present invention is not limited to those embodiments. Consequently, the scope of the present invention can be limited only by the following claims.

What is claimed is:

1. A reaction apparatus comprising:
a reaction section to receive supply of a reactant, the reaction section being set at a predetermined temperature to cause a reaction;
a plurality of electrodes provided to the reaction section;
a heat insulating container to house the reaction section therein through a heat insulating space; and
a supply/discharge section including a conductor to supply the reactant to the reaction section, and to discharge a reaction product from the reaction section, one end of the supply/discharge section being connected to the reaction section, the other end thereof penetrating a wall of the heat insulating container to an outside, wherein
at least one of the plurality of electrodes is electrically connected to the supply/discharge section.

2. The reaction apparatus according to claim 1, wherein
the supply/discharge section includes a plurality of pipe members made of a conductor, and
at least one end of the plurality of electrodes is electrically connected to at least one of the plurality of pipe members.

3. The reaction apparatus according to claim 1, wherein
the reaction section further includes a heating section to heat the reaction section to set to the predetermined temperature;
the heating section includes a heating wire to generate heat by receiving supply of electric power;
both ends of the heating wire form the plurality of electrodes; and
at least one of the ends of the heating wire is electrically connected to the supply/discharge section.

4. The reaction apparatus according to claim 3, wherein the heating wire is a metal thin film.

5. The reaction apparatus according to claim 3, further comprising a base plate, wherein the reaction section is provided on one side of the base plate, wherein
the supply/discharge section includes a plurality of pipe members made of a conductor, and
the plurality of pipe members and the heating wire are provided on the other side of the base plate.

6. The reaction apparatus according to claim 5, wherein
the base plate has electrical conductivity, and
the plurality of pipe members and the heating wire are provided on the other side of the base plate though an insulation film.

7. The reaction apparatus according to claim 5, wherein
the plurality of pipe members are connected on the other side of the base plate though an adhesion member having electrical conductivity, and
the adhesion member and at least one end of the heating wire of the heating section are electrically connected with each other.

8. The reaction apparatus according to claim 7, wherein the adhesion member is a metal plating layer.

9. The reaction apparatus according to claim 5, wherein
the plurality of pipe members are connected with the other side of the base plate though an adhesion member having electrical conductivity, and
the adhesion member and at least one end of the heating wire of the heating section are electrically connected to each other though a connection member.

10. The reaction apparatus according to claim 9, wherein
the connection member is a conductive wire.

11. The reaction apparatus according to claim 9, wherein
the connection member is a brazing filler metal.

12. The reaction apparatus according to claim 1, wherein
the reaction section includes:
a first reaction section to cause a reaction of the reactant, the first reaction section being set at a first temperature by the heating section;
a second reaction section to cause a reaction of the reactant, the second reaction section being set a second temperature lower than the first temperature by the heating section; and
a connection section disposed between the first reaction section and the second reaction section to transmit, between the first reaction section and the second reaction section, the reactant, and a reaction product produced by the reaction.

13. The reaction apparatus according to claim 12, wherein the supply/discharge section is connected to the second reaction section.

14. The reaction apparatus according to claim 12, wherein
the first reaction section receives supply of a first reactant to produce a first reaction product;
the second reaction section receives supply of the first reaction product to produce a second reaction product;
the first reactant is a vaporized mixture of water and a liquid fuel having a composition including hydrogen;
the first reaction section is a reformer to cause a reforming reaction of the first reactant;
the first reaction product includes hydrogen and carbon monoxide; and
the second reaction section is a carbon monoxide remover to remove the carbon monoxide included in the first reaction product.

15. The reaction apparatus according to claim 1, wherein
the reaction section has an electric power generation cell including two electrodes of a positive electrode and a negative electrode from which electric power is extracted by an electrochemical reaction of the reactant, the two electrodes being the plurality of electrodes, the electric power generation cell being set at a predetermined temperature, and
one of the two electrodes is electrically connected to the supply/discharge section.

16. The reaction apparatus according to claim 15, wherein solid oxide electrolyte is used in the electric power generation cell.

17. The reaction apparatus according to claim 15, wherein the reaction section further includes a combustor to burn an unreacted fuel gas discharged from the electric power generation cell to heat the electric power generation cell.

18. The reaction apparatus according to claim 15, wherein the reaction section further includes a reformer to cause a reforming reaction by receiving supply of a first reactant to produce a first reaction product;
the electric power generation cell causes an electrochemical reaction using the first reaction product as the reactant;
the first reactant is a vaporized mixture of a raw fuel including water and a liquid fuel having a composition including hydrogen; and
the first reaction product includes the hydrogen and carbon monoxide.

19. The reaction apparatus according to claim 18, wherein
the reformer performs the reforming reaction by heat propagating from the electric power generation cell.

20. The reaction apparatus according to claim 18, wherein the supply/discharge section includes a first connection section to couple the heat insulating container with the reformer and a second connection section to couple the reformer with the electric power generation cell.

21. The reaction apparatus according to claim 20, wherein
the reaction section further includes a vaporizer provided in the first connection section, and the vaporizer receives supply of the raw fuel, vaporizes the raw fuel by the heat propagating from the reformer to produce the mixture gas and supplies the mixture to the reformer.

22. The reaction apparatus according to claim 15, further comprising an output electrode wherein one end of the output electrode is connected to the other electrode of the electric power generation cell which is not electrically connected to the supply/discharge section and the other end penetrates a wall of the heat insulating container to an outside.

23. The reaction apparatus according to claim 22, wherein the output electrode has a sectional shape selected from the group consisting of a quadrilateral, a triangle, and a circle.

24. The reaction apparatus according to claim 22, wherein the output electrode has a stress relaxation structure including a plurality of bent portions.

25. The reaction apparatus according to claim 24, wherein the stress relaxation structure is provided in the heat insulating space between the wall, from which the output electrode of the heat insulating container is pulled out and the reformer.

26. The reaction apparatus according to claim 24, wherein the output electrode is bent to a shape selected from the group consisting of a right angle, an arc, and winding at the bent portions of the stress relaxation structure.

27. A reaction apparatus comprising:
a reaction section having an electric power generation cell including two electrodes of a positive electrode and a negative electrode, from which electric power is extracted by an electrochemical reaction of a reactant, the electric power generation cell being set at a predetermined temperature;
a heat insulating container to house the reaction section therein through a heat insulating space; and
a supply/discharge section including a conductor to couple the heat insulating container with the reaction section so as to supply a fuel for the electric generation to the reaction section and to discharge a reaction product from the reaction section, one end of the supply/discharge section being connected to the reaction section, the other end thereof penetrating a wall of the heat insulating container to an outside, wherein
one of the two electrodes in the electric power generation cell is electrically connected to the supply/discharge section.

28. The reaction apparatus according to claim 27, wherein solid oxide electrolyte is used in the electric power generation cell.

29. The reaction apparatus according to claim 27, wherein the reaction section further includes:
one output electrode, one end of the output electrode being connected to the other electrode which is not electrically connected to the supply/discharge section of the electric power generation cell, the other end of the output electrode penetrating a wall of the heat insulating container to an outside; and
a housing to house the electric power generation cell, the housing being penetrated by the output electrode, and
the output electrode and the housing are made of a same material.

30. The reaction apparatus according to claim 27, wherein
the reaction section further includes one output electrode, one end of the output electrode being connected to the other output electrode of the electric power generation cell, the other end of the output electrode penetrating a wall of the heat insulating container to an outside, and
a distance from the wall of the heat insulating container, from which the other output electrode is pulled out, to the other electrode which is not electrically connected to the supply/discharge section of the electric power generation cell, the other electrode being connected to the one end of the output electrode, is larger than a distance from the wall of the heat insulating container, from which the output electrode is pulled out, to the one of the two electrodes of the electric power generation cell.

31. The reaction apparatus according to claim 27, wherein
the reaction section further includes an output electrode, one end of the output electrode connected to the other electrode which is not electrically connected to the supply/discharge section of the electric power generation cell, the other end of the output electrode penetrating the wall of the heat insulating container to be pulled out to the outside, and a reformer to receive supply of a first reactant and to cause a reforming reaction to produce a first reaction product;
the electric power generation cell causes an electrochemical reaction using the first reaction product as the reactant;
the first reactant is a vaporized mixture of water and a liquid of a raw fuel including water and a liquid fuel having a composition including hydrogen;
the first reaction product includes the hydrogen and carbon monoxide;
the supply/discharge section includes a first connection section to couple the heat insulating container with the reformer, and a second connection section to couple the reformer with the electric power generation cell; and
a distance from the wall of the heat insulating container, from which the output electrode is pulled out, to the other electrode of the electric power generation cell, the other electrode being connected to the one end of the output electrode, is larger than a distance from the wall to the second connection section.

32. The reaction apparatus according to claim 31, wherein
the reaction section further includes a vaporizer to receive supply of the raw fuel, the vaporizer producing the mixture gas by vaporizing the raw fuel by heat propagating from the reformer to supply the mixture gas to the reformer, the vaporizer being provided in the first connection section.

33. The reaction apparatus according to claim 27, wherein
the reaction section further includes a combustor to burn an unreacted fuel gas discharged from the electric power generation cell to heat the electric power generation cell.

34. An electronic equipment comprising:
a reaction apparatus comprising:
a reaction section to receive supply of a reactant, the reaction section being set at a predetermined temperature to cause a reaction;
a plurality of electrodes provided to the reaction section;
a heat insulating container to house the reaction section therein through a heat insulating space;
a supply/discharge section including a conductor to supply the reactant to the reaction section, and to discharge a reaction product from the reaction section, one end of the supply/discharge section being connected to the reaction section, the other end thereof penetrating a wall of the heat insulating container to an outside, at least one of the plurality of electrodes is electrically connected to the supply/discharge section,
an electric power generation cell from which electric power is extracted by an electrochemical reaction of the reactant; and
wherein a load is driven based on the electric power extracted from the electric power generation cell.

35. The electronic equipment according to claim 34, wherein
the electric power generation cell is provided in the reaction section, the electric power generation cell including two electrodes of a positive electrode and a negative electrode, from which electric power is extracted, one of the two electrodes of the electric power generation cell being electrically connected to the supply/discharge section.

36. The electronic equipment according to claim 35, wherein
the electric power generation cell uses solid oxide electrolyte.

37. The electronic equipment according to claim 35, wherein
the reaction section in the reaction apparatus further includes a reformer to receive supply of a first reactant to cause a reforming reaction, the reformer producing a first reaction product;
the electric power generation cell causes an electrochemical reaction using the first reaction product as the reactant;
the first reactant is a vaporized mixture of a raw fuel including water and a liquid fuel having a composition including hydrogen;
the first reaction product includes hydrogen and carbon monoxide;
the supply/discharge section includes a first connection section to couple the heat insulating container with the reformer, and a second connection section to couple the reformer with the electric power generation cell; and
a distance from the wall of the heat insulating container through which the other electrode of the electric power generation cell that is not electrically connected to the supply/discharge section is pulled out is larger than a distance from the wall to the second connection section.

38. The electronic equipment according to claim 37, wherein
the reaction section further includes a vaporizer provided in the first connection section, the vaporizer receives supply of water and a liquid fuel having a composition including hydrogen, vaporizes the water and the liquid fuel by heat propagating from the reformer to produce the mixture gas and supplies the mixture gas to the reformer.

39. The electronic equipment according to claim 35, wherein
the reaction section further includes a combustor to burn an unreacted fuel gas discharged from the electric power generation cell to heat the electric power generation cell.
